(19) United States
(12) Patent Application Publication
(10) Pub. No.: US 2024/0411542 A1
(43) Pub. Date: Dec. 12, 2024

(54) APPARATUSES, COMPUTER-IMPLEMENTED METHODS, AND COMPUTER PROGRAM PRODUCTS FOR IMPROVED AUTOMATION OF SOFTWARE CHANGE MANAGEMENT

(71) Applicant: HONEYWELL INTERNATIONAL INC., CHARLOTTE, NC (US)

(72) Inventors: McMillan Goyal, Bengaluru (IN); Abhiram Puranam, Bengaluru (IN); Shrai Lakshman R., Bengaluru (IN); Anjeneya Dubey, Robbinsville, NJ (US)

(21) Appl. No.: 18/332,557

(22) Filed: Jun. 9, 2023

(51) Int. Cl. G06F 8/65; G06F 8/41

(52) U.S. Cl. CPC G06F 8/65; G06F 8/433

(57) ABSTRACT

Embodiments of the disclosure provide for improved automation of software change management. Such embodiments enable automatically managing and testing software modifications. Some embodiments receive a change request data object indicative of a software modification, generate a risk level of the software modification based on the change request data object, and generate a test scheduling data object based on the change request data object and the risk level, where the test scheduling data object is indicative of a testing operation for the software modification. Some embodiments initiate performance of the testing operation at a testing environment and receive, from the testing environment, test performance data. Some embodiments determine a test failure based on the test performance data and, in response to determining the test failure, generate a communication bridge between a subset of a plurality of computing devices based on the test failure and a development flow data object.

### TECHNOLOGICAL FIELD

Embodiments of the present disclosure are generally directed to automating management of software modifications.

### BACKGROUND

Management of changes to software is typically performed by multiple human operators. For example, to ensure proper functioning and throughput of software changes, each modification to a software program or platform may be manually reviewed and tested, such as to determine if modified software passes one or more performance tests. However, the high level of human dependency in previous approaches may result in software testing errors and development delays due to operator oversights when managing software modifications.

Applicant has discovered various technical problems associated with conventional management of software changes. Through applied effort, ingenuity, and innovation, Applicant has solved many of these identified problems by developing the embodiments of the present disclosure, which are described in detail below.

### BRIEF SUMMARY

In general, embodiments of the present disclosure herein provide for improved automation of software change management. Other implementations for automatically managing modifications to software will be, or will become, apparent to one with skill in the art upon examination of the following figures and detailed description. It is intended that all such additional implementations be included within this description be within the scope of the disclosure, and be protected by the following claims.

In accordance with a first aspect of the disclosure, a computer-implemented method for improved automation of software change management is provided. The computer-implemented method is executable utilizing any of a myriad of computing device(s) and/or combinations of hardware, software, firmware. In some example embodiments an example computer-implemented method includes receiving a change request data object indicative of a software modification. The example computer-implemented method further includes generating a risk level of the software modification based on the change request data object. The example computer-implemented method further includes generating a test scheduling data object based on the change request data object and the risk level of the software modification. The test scheduling data object may indicate at least one testing operation for the software modification. The example computer-implemented method further includes initiating performance of the at least one testing operation at a testing environment. The example computer-implemented method further includes receiving, from the testing environment, test performance data. The example computer-implemented method further includes determining at least one test failure based on the test performance data. The example computer-implemented method further includes, in response to determining the at least one test failure, generating a communication bridge between at least a subset of a plurality of computing devices based on the at least one test failure and a development flow data object.

In some example embodiments, the computer-implemented method further includes, in response to determining the risk level of the software modification exceeds a risk threshold, flagging the change request data object for administrator approval. The example computer-implemented method may further include providing an administrator approval request to one of the plurality of computing devices based on the development flow data object.

In some example embodiments, the computer-implemented method further includes modifying a distributed scheduling data object based on the test scheduling data object. In some example embodiments, the example computer-implemented method further includes providing a graphical user interface (GUI) indicative of the distributed scheduling data object to the plurality of computing devices. The example computer-implemented method may further include rendering the test scheduling data object on the GUI in one of a plurality of colors based on the risk level of the software modification.

In some example embodiments, the at least one testing operation includes one or more test case data objects. In some example embodiments, the computer-implemented method further includes generating, using a machine learning model, at least one test case correction based on the at least one test failure. The computer-implemented method may further include applying the at least one test case correction to the one or more test case data objects.

In some example embodiments, the computer-implemented method further modifying a status of the change request data object based on the at least one test failure. In some example embodiments, the test scheduling data object is indicative of the status of the change request data object.

In some example embodiments, the computer-implemented method further includes providing a notification indicative of the test scheduling data object to a plurality of computing devices based on the development flow data object. In some embodiments, generating the communication bridge may include generating a teleconference communication session between at least the subset of the plurality of computing devices.

In some example embodiments, the computer-implemented method further includes generating a second test scheduling data object. In some example embodiments, the computer-implemented method further includes providing a notification indicative of the second test scheduling data object to at least the subset of the plurality of computing devices. In some example embodiments, the computer-implemented method further includes modifying a distributed scheduling data object based on the second test scheduling data object.

In some example embodiments, the computer-implemented method further includes querying the development flow data object based on the at least one test failure to determine the subset of the plurality of computing devices. In some example embodiments, the development flow data object defines associations between a plurality of user accounts and the plurality of computing devices.

In some example embodiments, the computer-implemented method further includes providing a notification indicative of the at least one testing operation to at least a subset of the plurality of computing devices based on the development flow data object.

In some example embodiments, the computer-implemented method further includes providing a notification indicative of the communication bridge and the at least one test failure to at least a subset of the plurality of computing devices based on the at least one test failure and the development flow data object.

In some example embodiments, the computer-implemented method further includes generating, based on the at least one test failure, at least one correction data object indicative of one or more service-level agreement (SLA) impacts. In some example embodiments, the computer-implemented method further includes performing one or more root cause corrective actions (RCCAs) on the software modification based on the at least one correction data object.

In some example embodiments, the computer-implemented method further includes generating an incident report based on the at least one test failure. In some example embodiments, the computer-implemented method further includes providing the incident report to the plurality of computing devices.

In some example embodiments, the change request data object indicates a downtime metric associated with the at least one testing operation. In some example embodiments, the computer-implemented further includes generating the risk level based on the downtime metric.

In some example embodiments, the at least one testing operation includes a simulated graphical user interface test.

In some example embodiments, the at least one testing operation includes a plurality of testing operations. In some example embodiments, the computer-implemented method further includes determining an outcome of each of the plurality of testing operations. In some example embodiments, the computer-implemented method further includes generating an incident report based on the outcome of each of the plurality of testing operations. In some example embodiments, the computer-implemented method further includes providing the incident report to at least one of the plurality of computing devices based the development flow data object. In some embodiments, the incident report indicates, from the plurality of testing operations, a quantity of passed testing operations, a quantity of skipped testing operations, and a quantity of failed testing operations.

In accordance with another aspect of the present disclosure, a computing apparatus for improved automation of software change management is provided. The computing apparatus in some embodiments includes at least one processor and at least one non-transitory memory, the at least non-transitory one memory having computer-coded instructions stored thereon. The computer-coded instructions in execution with the at least one processor causes the apparatus to perform any one of the example computer-implemented methods described herein. In some other embodiments, the computing apparatus includes means for performing each step of any of the computer-implemented methods described herein.

In accordance with another aspect of the present disclosure, a computer program product for improved automation of software change management is provided. The computer program product in some embodiments includes at least one non-transitory computer-readable storage medium having computer program code stored thereon. The computer program code in execution with at least one processor is configured for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 illustrates a block diagram of an example apparatus that may be specially configured in accordance with at least some example embodiments of the present disclosure;

FIG. 3 illustrates an example data flow in accordance with at least some example embodiments of the present disclosure;

FIG. 4 illustrates an example data architecture in accordance with at least some example embodiments of the present disclosure;

FIG. 5 illustrates a flowchart depicting operations of an example process for automating management of a software modification in accordance with at least some example embodiments of the present disclosure;

FIG. 6. is an example user interface that depicts a distributed scheduling data object, where at least some of the various named aspects of the UI may be generated in accordance with the previously described and depicted figures.

FIG. 7. is an example user interface that depicts a selectable field for accessing a distributed scheduling data object, where at least some of the various named aspects of the UI may be generated in accordance with the previously described and depicted figures.

FIG. 8. is an example user interface that depicts a test scheduling data object, where at least some of the various named aspects of the UI may be generated in accordance with the previously described and depicted figures.

FIG. 9. is an example user interface that depicts a notification indicative of a change request data object, where at least some of the various named aspects of the UI may be generated in accordance with the previously described and depicted figures.

FIG. 10. is an example user interface that depicts a notification indicative of a change request data object, where at least some of the various named aspects of the UI may be generated in accordance with the previously described and depicted figures.

FIG. 11. is an example user interface that depicts a change request data object, where at least some of the various named aspects of the UI may be generated in accordance with the previously described and depicted figures.

FIG. 12. is an example user interface for managing a change request data object, where at least some of the various named aspects of the UI may be generated in accordance with the previously described and depicted figures.

FIG. 13. is an example user interface that depicts a notification indicative of a testing operation, where at least some of the various named aspects of the UI may be generated in accordance with the previously described and depicted figures.

FIG. 14. is an example user interface that depicts an incident report, where at least some of the various named aspects of the UI may be generated in accordance with the previously described and depicted figures.

FIG. 15. is an example user interface that depicts a notification indicative of a test failure, where at least some of the various named aspects of the UI may be generated in accordance with the previously described and depicted figures.

FIG. 16. is an example user interface that depicts a test scheduling data object, where at least some of the various named aspects of the UI may be generated in accordance with the previously described and depicted figures.

FIG. 17. is an example user interface that depicts a notification indicative of a communication bridge, where at least some of the various named aspects of the UI may be generated in accordance with the previously described and depicted figures.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Embodiments of the present disclosure provide a myriad of technical advantages in the technical field of software change management. Some embodiments provide and utilize automated processes and techniques for testing software modifications, determining software modification test failures, and generating communication bridges between software stakeholders to address software modification test failures. Such processes and techniques may increase throughput of software modification testing and development and reduce instances of testing or development errors. Some embodiments generate risk levels of software modifications such that testing operations for software modifications may be approved or denied based on a predicted impact to a product or service, such as estimated downtime. Some embodiments generate incident reports based on test failures and/or test performance data, which may be presented to particular groups of software stakeholders for optimized and efficient review by particular software stakeholders with relevant duties and purviews. Some embodiments generate communication bridges between computing devices of software stakeholders based on a development flow data object that defines associations between a software modification, a software program to-be-modified, and computing devices of software stakeholders.

### Definitions

“Software program” refers to any operating information embodied by instructions executed by a computer or computing network. In some contexts, a software program includes program code executable by logic circuitry of one or more computing devices, for example a server processor.

“Software modification” refers to any change to a software program. In some contexts, a software modification includes a change to program code that defines a software program.

“Change request data object” refers to a data construct that defines a request to apply a software modification to a software program. In some contexts, a software modification includes performing one or more testing operations for the software modification. In some embodiments, the change request data object indicates a software modification. For example, in some contexts, the change request data object indicates a software program and include a description of a software modification to be applied to the software program. In some embodiments, the change request data object includes a requested time at which to perform a testing operation for a software modification. For example, in some contexts, the change request data object includes a date and/or a duration of a testing operation for a software modification. In some embodiments, the change request data object includes one or more risk parameters that indicate, or from which may be determined, a risk level. In some embodiments, the change request data object includes an indication of one or more services associated with or impacted by a software modification. In some embodiments, the change request data object includes a description of one or more risks associated with applying the software modification to the software program and one or more risks associated with not applying the software modification to the software program. In some embodiments, the change request data object includes a status that can be configured to one or more states respective to the software modification. In some contexts, non-limiting examples of the status include awaiting implementation, awaiting testing, awaiting administrator approval, test failure, test pass, and/or the like.

In some embodiments, the change request data object includes or indicates a product type associated with the software modification or corresponding software program. In some contexts, the product type indicates an association between the software program to be modified and a computing environment in which the software program is implemented (e.g., a computing platform or service) or one or more functions provided by the computing environment via use of the software program. For example, in some contexts, the product type indicates a particular software as a service (SaaS) or on-premises computing environment with which the software program is associated. In some embodiments, the change request data object includes a priority level of applying the software modification to the corresponding software program and/or performing a testing operation for the software modification. For example, in some contexts, the change request data object indicates a date by which the software modification must be applied or tested. As a particular example, in some contexts, as the change request data object indicates a software program release date.

“Risk level” refers to a data construct that defines a predicted impact of performing a testing operation for a software modification on one or more services or functions provided by a software program being modified and/or additional software programs that utilize output from or provide input to the software program being modified. In some embodiments, the impact includes a predicted amount of downtime for a computing environment. For example, in some contexts, the impact is a predicted time period of unavailability of one or more functions provided by a computing platform or service. As another example, in some contexts, a risk level includes an expected downtime for a SaaS platform when a testing operation is performed for a software modification. In some embodiments, the risk level embodies one or more risk categories respective to performing a testing operation for a software modification, or a status of the testing operation. For example, in some contexts, the risk category includes critical risk, high risk, medium risk, low risk, no or unspecified risk, cancelled testing operation, and/or the like. In some embodiments, each risk level is associated with one of a plurality of colors such that a risk level of a software modification, or associated testing operation, may be indicated in a display of a test scheduling data object and/or distributed scheduling data object based on a rendered color. For example, in some contexts, a critical risk level is associated with a red color, a high risk level is associated with a yellow color, a medium risk level is associated with a light blue color, a low risk level is associated with a green color, a no or unspecified risk level is associated with a grey color, and a cancelled testing operation is associated with a black color.

“Risk threshold” refers to a data construct that defines a maximum risk level at or above which a change request data object is flagged for administrator approval. In some contexts, flagging a change request data object includes providing an administrator approval request to an administrator user account or administrator computing device. In one example, in some contexts, a risk threshold includes a maximum downtime (e.g., 1 hour, 2 hours, or any suitable interval) for performing one or more testing operations for the software modification. In another example, in some contexts, a risk threshold includes a maximum number of computing environment services or functions that may be impacted during performance of a testing operation for a software modification.

“Administrator approval request” refers to a data construct by which approval or denial for applying a software modification and/or performing a testing operation for a software modification is requested. For example, in some contexts, an administrator approval request is a request to an administrator computing device to provide a user input indicative of an approval or denial of a change request data object. In some embodiments, the administrator approval request includes or indicates a change request data object. For example, in some contexts, the administrator approval request includes or indicates one or more risk parameters from the change request data object. In some contexts, non-limiting examples of the risk parameter include whether the software modification is associated with a critical service or functionality of a computing environment, whether the software modification impacts additional services or functionalities (e.g., upstream or downstream services or functionalities respective to a service or functionality embodied by the software program to be modified), a level of downtime estimated for performing a testing operation for the software modification, and/or the like. In another example, additionally or alternatively, in some contexts, the administrator approval request includes a risk of applying or not applying the software modification, a high-level summary of the software modification, a detailed description of the software modification, one or more product types associated with the software modification, a priority level of applying and/or performing a testing operation for the software modification, and/or the like.

“Test scheduling data object” refers to a data construct that defines a time period or interval for performing one or more testing operations and/or another action. In one example, in some contexts, a test scheduling data object includes an entry for a digital calendar that includes a date and a duration. In some embodiments, the test scheduling data object is associated with one or more user accounts. For example, in some contexts, a test scheduling data object is an entry to a particular digital calendar associated with a particular user account. In some embodiments, a test scheduling data object is generated for and applied to multiple digital calendars, where each of the digital calendars is associated with a different user account. In some embodiments, a test scheduling data object is generated for and applied to one or more digital calendars based on a development flow data object that indicates associations between a software program to be modified and one or more user accounts and/or computing devices.

“Testing operation” refers to one or more actions or processes for assessing performance of a software modification, or software program modified thereby, in one or more tasks, duties, intended functions, and/or operations. For example, in some contexts, a testing operation includes obtaining and examining the artifacts and behavior of the modified software program under test by validation and verification. In some embodiments, a testing operation includes a simulated graphical user interface test configured to simulate one or more user inputs to a modified software program such that interactivity and outputs of the modified software program may be obtained and analyzed. In some embodiments, a testing operation is associated with one or more test case data objects.

“Test case data object” refers to a data construct that defines inputs, execution conditions, testing procedure, and expected results for a testing operation to be executed associated with a software program. In some contexts, the inputs, execution, conditions, testing procedure, and expected results are defined for a particular software program that has been modified by a software modification. In some embodiments, the test case data object defines a particular software testing objective. For example, in some contexts, the test case data object is a software testing objective for exercising a particular software program path or to verify compliance with an intended functionality. In some embodiments, the test case data object defines a simulated scenario of user inputs to and expected outputs for the software program. For example, in some contexts, a test case data object defines one or more user inputs and expected outputs or behaviors for a simulated graphical user interface test.

“Testing environment” refers to a computing environment, embodied in hardware, software, firmware, and/or any combination thereof, that performs one or more testing operations. In some contexts, a testing environment is defined on a particular type of computing environment, for example a dedicated server. In some embodiments, the testing environment includes a software and/or hardware configuration for performing testing operations. In some embodiments, the testing environment includes one or more test case data objects for performing one or more testing operations. In some embodiments, the testing environment is configured to be independent from and inaccessible to one or more end-user devices. For example, in some contexts, the testing environment is any operating environment other than a production environment. In some embodiments, the testing environment includes, or simulates, computer systems, databases, and hardware used in an end-user-facing production environment that test or evaluate the functionality, interoperability or stability of a software program without impacting the production environment or upstream and downstream software product operations.

“Test performance data” refers to any data associated with or generated by a software program during performance of a testing operation that indicates at least one tracked metric value during the performance of the testing operation. In some embodiments, the test performance data includes or indicates an outcome of one or more testing operations and/or test case data objects. For example, in some contexts, test performance data includes outputs generated by a software program during a testing operation, one or more comparisons between the outputs and one or more expected outputs, one or more metrics associated with generating the outputs (e.g., runtime, stability, etc.), and/or the like. In some embodiments, the test performance data includes data indicative of whether a software program passed, failed, or skipped one or more test case data objects during performance of a testing operation. In some embodiments, test performance data includes one or more specification files that indicate or summarize performance of a software program in one or more testing operations.

“Test case correction” refers to a modification to one or more test case data objects that facilitates adjusting composition of the test case data object to correct instances in which a software program fails or skips a test case. In some embodiments, a test case correction includes a modification to one or more inputs, execution conditions, testing procedure, or expected results for a testing operation. For example, in some contexts, a test case correction includes adjustment of a simulated user interface test case data object to rearrange one or more selectable fields based on a historical user interface or other reference template for a user interface. In some embodiments, the test case correction is generated using a model and applied to the corresponding test case data object. For example, in some contexts, the test case correction is generated by an algorithmic, statistical, and/or machine learning model and applied to the corresponding test case data object.

“Communication bridge” refers to any electronic communication channel between two or more computing devices. In some embodiments, a communication bridge is a telecommunication session between two or more computing devices. In some contexts, non-limiting examples of a communication bridge include a video conference, telephone call, inter-or intra-network electronic messaging session (e.g., instant messaging, electronic mail, SMS messaging), and/or the like.

“Development flow data object” refers to a data construct that defines associations between a software program and software program stakeholders. Non-limiting examples of such associations with software program stakeholders include, without limitation, software developers, software quality assurance team members, software project managers, testing operation support personnel, software customers, and/or the like. In some embodiments, a development flow data object indicates responsibilities, purviews, duties, and/or the like of various stakeholders of a software program. For example, in some contexts, a development flow data object indicates, for each of a plurality of user accounts associated with a software program, a technical role of the user. In some contexts, non-limiting examples of such technical roles include front-end engineer, back-end engineer, full-stack engineer, web designer, data scientist, software architect, project manager, quality assurance, DevOps engineer, security engineer, cloud architect, integration engineer, sales representative, technical support, customer, test user, and/or the like. In another example, in some contexts, the development flow data object identifies a computing device of each of a plurality of user accounts associated with a software program. In another example, in some contexts, the development flow data object indicates portions of a software program and/or software program functionalities for which one or more user accounts are responsible. In some embodiments, the development flow data object indicates associations between test case data objects and user accounts. For example, in some contexts, the development flow data object indicates associations between a first test case data object and a first subset of a plurality of user accounts, and/or or computing devices, and a second test case data object and a subset of the plurality of user accounts. In some embodiments, the indication of associations between test case data objects and subsets of user accounts, and/or computing devices, responsible for a software program allow for generation of customized communication bridges that facilitates management of a software modification on a test case data object-by-test case data object manner. For example, in some contexts, in response to a software program failing a first test case, a communication bridge is generated between the computing devices of a first subset of user accounts, and, in response to a test failure for a second test case, a communication bridge is generated between the computing devices of a second subset of user accounts. In some embodiments, the development flow data object includes one or more service-level agreements (SLAs). In some embodiments, the development flow data object defines one or more processes for performing root cause corrective actions (RCCAs) to mitigate SLA impacts. For example, in some contexts, an RCCA includes generating a communication bridge between a subset of a plurality of user accounts, and/or computing devices thereof, based on the SLA impact.

“Distributed scheduling data object” refers to a data construct that records occurrences of events, appointments, and/or other activities and is accessible by and/or provided to a plurality of user accounts and/or computing devices associated with such a plurality of user accounts. In some embodiments, the recorded occurrence of an event includes a date of the event, a duration of the event, a description of the event, indications of one or more user entities, software programs, software modifications, and/or testing operations associated with the event, and/or the like. For example, in some contexts, a distributed scheduling data object includes a collaborative digital calendar accessible by a plurality of members of a software development team. In some embodiments, the distributed scheduling data object includes a graphical user interface (GUI) configured to receive user inputs. For example, in some contexts, the distributed scheduling data object includes a GUI configured to receive one or more user inputs for generating and configuring a change request data object.

“Notification” refers to any electronic message that is transmissible and/or renderable to a computing device for display and/or processing. Non-limiting examples of a notification include an electronic mail (e-mail) message, SMS text messages, instant messages, telephone calls, push alerts, and/or the like. In some embodiments, the notification includes or indicates information associated with automated management of software modifications. For example, in some contexts, the notification indicates and/or includes information associated with a change request data object. In another example, in some contexts, the notification indicates and/or includes information associated with a test scheduling data object and/or testing operation. In another example, in some contexts, the notification indicates and/or includes information associated with one or more test failures. In another example, in some contexts, the notification includes an incident report. In another example, in some contexts, the notification indicates and/or includes information associated with a communication bridge.

“Service-level agreement (SLA) impact” refers to any impact of a software modification on the ability of a software program modified by the software modification to fulfill obligations defined in an SLA corresponding to the software program. In some contexts, the SLA is a data construct that defines expectations of a software program between a provider or creator of the software program and a customer for the software program. For example, in some contexts, the SLA describes products or services to be delivered, one or more points of contact for end-user problems, and one or more metrics by which the performance of the software program is assessed and approved. In some embodiments, the SLA impact includes any change in the ability of a software program to satisfy SLA-indicated metrics or expectations.

“Root cause corrective action” and “RCCA” refers to any action or process that identifies and mitigates, in a software program or software modification, a cause of an SLA impact. For example, in some contexts, an RCCA includes identifying one or more aspects of a software modification that caused a modified software program to experience test failure in one or more testing operations. In some embodiments, the RCCA further includes performing one or more actions to modify the software modification to remove otherwise mitigate the identified aspect that resulted in test failure and/or one or more SLA impacts. In some embodiments, the RCCA includes generating a communication bridge between one or more computing devices based on a development flow data object.

“Incident report” refers to a data construct that indicates initiated or completed status information associated with performance of a software modification, or software program modified thereby, as part of one or more testing operations. In some embodiments, the incident report indicates performance of the software modification in one or more testing operations and/or test cases. For example, in some contexts, the incident report indicates a quantity of success (“passed”) testing operations, a quantity of skipped testing operations, and/or a quantity of failed testing operations. In some embodiments, the incident report indicates and/or includes a date of the testing operation, a duration of the testing operation, a file from which testing operation results may be accessed or observed, a file from which the software modification may be accessed or observed, and/or the like.

“Test failure” refers to electronically managed data indicating a detected or otherwise determined failure of a software modification, or software program modified thereby, to successfully perform one or more testing operations, test cases, and/or portions thereof. In some embodiments, a test failure includes an instance in which a modified software program generates an output that deviates from an expected output (e.g., any deviation or deviation beyond a predetermined threshold). Additionally, or alternatively, in some embodiments, a test failure includes a failure of a modified software operation to perform a testing operation and/or test case data object within a predetermined interval (e.g., 1 second, 3 seconds, 1 minute, or any suitable value).

“Model” refers to any algorithmic, statistical, and/or machine learning model that generates a particular output, or plurality thereof, based at least in part on one or more inputs. Non-limiting examples of models include linear programming (LP) models, regression models, dimensionality reduction models, ensemble learning models, reinforcement learning models, supervised learning models, unsupervised learning models, semi-supervised learning models, Bayesian models, decision tree models, linear classification models, artificial neural networks, association rule learning models, hierarchical clustering models, cluster analysis models, anomaly detection models, deep learning models, feature learning models, and combinations thereof. In some embodiments, the model generates, as output, one or more test case corrections based on one or more inputs including a current test case data object, one or more historical test case data objects or other templates for test case data objects, test performance data, and/or the like. For example, the model may be a machine learning model configured to determine that a simulated graphical user interface (GUI) test omits a test case data object identifier (e.g., which may be used to determine parameters or other aspects of the test case data object). In some embodiments, the machine learning model is further configured to determine one or more properties of the simulated GUI test, identify one or more historical simulated GUI tests based on the one or more properties, and generate a test case correction to modify the simulated GUI test based on properties of the historical simulated GUI test. In some embodiments, performing the tase case correction includes modifying the simulated GUI test to include an appropriate test case data object identifier and/or rearranging or adding selectable fields to the simulated GUI of the test case.

### Example Systems and Apparatuses of the Disclosure

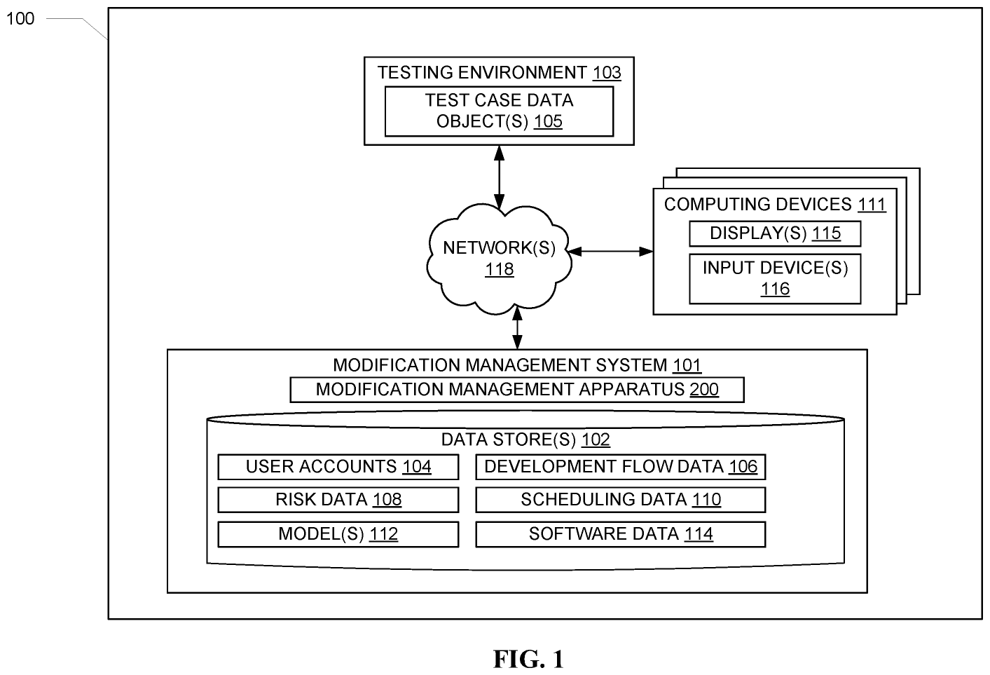

FIG. 1 illustrates a block diagram of a system that may be specially configured within which embodiments of the present disclosure may operate. Specifically, FIG. 1 depicts an example system 100. As illustrated, the system 100 includes a modification management system 101, an optional testing environment 103, and a plurality of computing devices 111. In some embodiments, the computing devices 111 are configured to provide change request data objects indicative of software modifications, or inputs from which a change request data object may be generated, to the modification management system 101. In some embodiments, the modification management system 101 is configured to receive a change request data object indicative of a software modification and automatically perform various operations to automatically manage the software modification, including generating a risk level of the software modification, generating a test scheduling data object, initiating performance of one or more testing operations for the software modification, receiving test performance data, determining a test failure, and generating a communication bridge between two or more computing devices 111 in response to the test failure, and potentially other operations. In some embodiments, the testing environment 103 is a computing environment configured to perform one or more testing operations for a software modification. For example, the testing environment 103 includes a software and/or hardware configuration for performing testing operations. In some embodiments, the testing environment 103 includes one or more test case data objects 105 for performing one or more testing operations. In some embodiments, the test case data object 105 is a data construct that defines inputs, execution conditions, testing procedure, and expected results for a testing operation to be executed for a software program, such as a software program that has been modified by a software modification. The testing environment 103 may be representative of a plurality of environments, as will be appreciated.

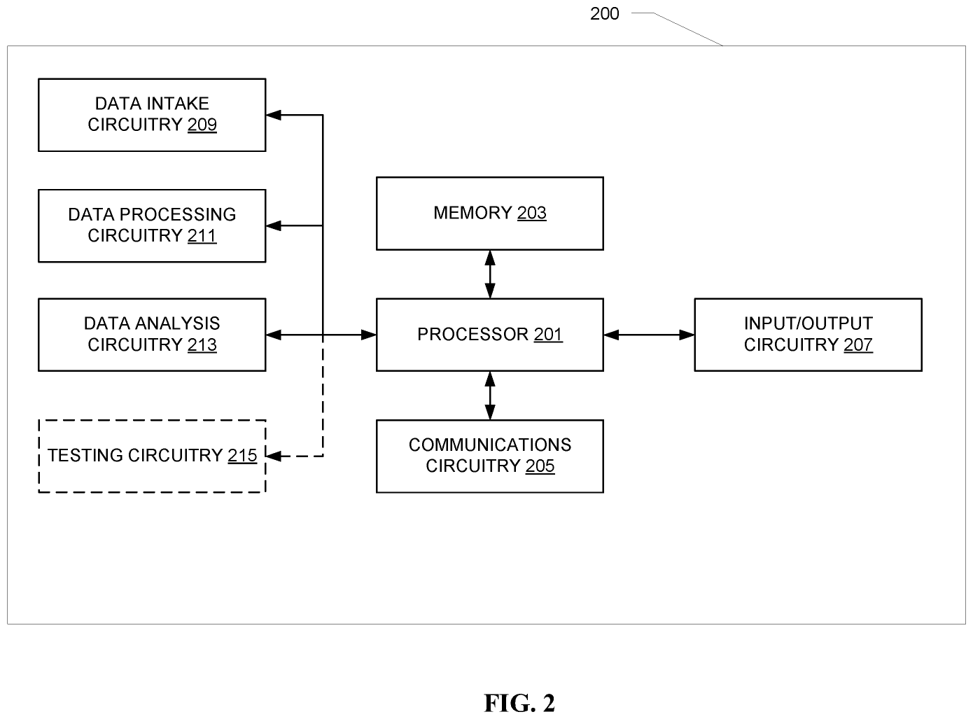

In some embodiments, the modification management system 101 is embodied as, or includes one or more, of a modification management apparatus 200 (e.g., as further illustrated in FIG. 2 and described herein). Various applications and/or other functionality may be executed in the modification management system 101 and/or modification management apparatus 200 according to various embodiments.

In some embodiments, the modification management system 101 includes, but is not limited to, the one or more modification management apparatuses 200 and one or more data stores 102. The various data in the data store 102 may be accessible to one or more of the modification management system 101, the modification management apparatus 200, and the computing device 111. The data store 102 may be representative of a plurality of data stores 102 as can be appreciated. The data stored in the data store 102, for example, is associated with the operation of the various applications, apparatuses, and/or functional entities described herein. The data stored in the data store 102 may include, for example, user accounts 104, development flow data 106, risk data 108, scheduling data 110, models 112, and software data 114.

In some embodiments, the user account 104 include credentials for a user, such as a name, username, contact information (e.g., email address, phone number, and/or the like). In some embodiments, the user account 104 includes technical roles, technical responsibilities, and/or other duties of the corresponding user. In some embodiments, the user account 104 includes an indication of a computing device 111 with which the corresponding user is associated. In some embodiments, the user account 104 includes associations between the user account 104 and scheduling data 110, such as one or more test scheduling data objects, one or more communication bridges, and/or one or more distributed scheduling data objects. In some embodiments, the user account 104 includes associations between the user account 104 and software data 114, such as particular software programs, software modifications, products, service-level agreements, and/or the like. In some embodiments, the user account 104 includes associations between the user account 104 and one or more change request data objects, one or more testing operations, test performance data, and/or test failures.

In some embodiments, the development flow data 106 includes one or more development flow data objects that defines associations between software data 114, such as a software program, and software program stakeholders, such as user accounts 104 and/or corresponding computing devices 111. In some embodiments, the development flow data 106 indicates responsibilities, purviews, duties, and/or the like of user accounts 104 respective to software data 114, such as one or more software programs. In some embodiments, the development flow data 106 may indicate portions of a software program and/or software program functionalities for which one or more user accounts 104 are responsible. In some embodiments, the development flow data 106 may indicate associations between test case data objects 105 and user accounts 104. The modification management system 101 may use the associations between software data 114, test case data objects 105, and user accounts 104 (e.g., and/or corresponding computing devices 111) to generate customized communication bridges for managing a software modification, such as by generating a communication bridge between a subset of user accounts 104 and/or computing devices 111 responsive to determining a test failure for a particular software modification. For example, in response to determining a test failure for a software program respective to a first test case data object 105, the modification management system 101 may generate a communication bridge between the computing devices 111 of a first subset of user accounts 104 based on the development flow data 106 associated with the software program. In response to determining a test failure for the same software program respective to second test case data object 105, the modification management system may generate a second communication bridge between the computing devices 111 of a second subset of user accounts 104 based on the development flow data 106. In some embodiments, the development flow data 106 defines associations between one or more service-level agreements (SLAs) and one or more user accounts 104. In some embodiments, the development flow data 106 defines one or more processes for performing root cause corrective actions (RCCAs) to mitigate SLA impacts, such as by generating a communication bridge between a subset of a plurality of user accounts 104, and/or corresponding computing devices 111, based on the SLA impact.

In some embodiments, the risk data 108 includes one or more rules, algorithms, or other mechanisms for generating a risk level based on one or more risk parameters. In some embodiments, the risk data 108 includes one or more risk thresholds, such as one or more predetermined thresholds for downtime metrics associated with testing software modifications. In some embodiments, the risk threshold defines a maximum risk level at or above which a change request data object may be flagged for administrator approval, which may include providing an administrator approval request to an administrator user account or administrator computing device. In one example, a risk threshold may include a maximum downtime, such as 1 hour, 2 hours, or any suitable interval, for performing one or more testing operations for the software modification. In another example, a risk threshold may include a maximum number of computing environment services or functions that may be impacted during performance of a testing operation for a software modification. In some embodiments, the risk data 108 includes one or more rules for approving or denying change request data objects and/or providing an administrator approval request to an administrator computing device 111 for approval or denial of a change request data object. For example, the risk data 108 may include a rule for automatically flagging a change request data object for administrator approval when the associated software modification includes an expected downtime in excess of a predetermined threshold. In some embodiments, the risk data 108 includes one or more rules for configuring an appearance of a test scheduling data object based on a risk level of the associated software modification to-be-tested. For example, the risk data 108 may define a plurality of risk levels. Each risk level may be associated with one of a plurality of colors such that a risk level of software modification may be indicated in a display of a test scheduling data object and/or distributed scheduling data object based on a rendered color. For example, a critical risk level may be associated with a red color, a high risk level may be associated with a yellow color, a medium risk level may be associated with a light blue color, a low risk level may be associated with a green color, a no or unspecified risk level may be associated with a grey color, and a cancelled testing operation may be associated with a black color.

In some embodiments, the scheduling data 110 includes one or more test scheduling data objects, one or more distributed scheduling data objects, and/or data for generating or modifying test scheduling data objects and distributed scheduling data objects. For example, the scheduling data 110 may include data for generating or modifying a collaborative digital calendar accessible by a plurality of user accounts 104 via associated computing devices 111. In some embodiments, the scheduling data 110 includes data for generating, modifying, and/or rendering graphical user interfaces (GUI) for displaying and managing test scheduling data objects and distributed scheduling data objects. In some embodiments, the scheduling data 110 includes scheduling data objects associated with particular user accounts 104, such as personal digital calendars, such that the modification management system 101 may use the scheduling data 110 to determine periods of user availability (or unavailability) for use in generating communication bridges between user accounts 104 or associated computing devices 111.

In some embodiments, the models 112 include one or more algorithmic and/or machine learning models configured to generates a particular output, or plurality thereof, based at least in part on one or more inputs. For example, the models 112 may include a machine learning model configured to generate test case corrections based on one or more test failures and/or corresponding test performance data. In some embodiments, the models 112 include one or more algorithmic and/or machine learning models configured to generate recipient lists for providing notifications to various user accounts 104, or computing devices 111, based on development flow data 106, scheduling data 110, and/or software data 114. For example, the models 112 may include a machine learning model configured to determine a subset of a plurality of computing devices 111 to which the modification management system 101 may provide a notice indicative of a test scheduling data object, a test failure, and/or a communication bridge. Non-limiting examples of models 112 include linear programming (LP) models, regression models, dimensionality reduction models, ensemble learning models, reinforcement learning models, supervised learning models, unsupervised learning models, semi-supervised learning models, Bayesian models, decision tree models, linear classification models, artificial neural networks, association rule learning models, hierarchical clustering models, cluster analysis models, anomaly detection models, deep learning models, feature learning models, and combinations thereof. In some embodiments, a model 112 generates, as output, one or more test case corrections based on software data 114, such as a current test case data object, one or more historical test case data objects or other templates for test case data objects, test performance data, and/or the like. For example, the model 112 may be a machine learning model configured to determine that a simulated graphical user interface (GUI) test omits a test case data object identifier (e.g., which may be used to determine parameters or other aspects of the test case). The machine learning model may be further configured to determine one or more properties of the simulated GUI test, identify one or more historical simulated GUI tests based on the one or more properties, and generate a test case correction to modify the simulated GUI test based on properties of the historical simulated GUI test.

In some embodiments, the software data 114 includes one or more software programs and/or identifiers, such as file names and locations, for accessing and observing one or more software programs. For example, the software data 114 includes one or more sets of operating information used by a computer or computing network to perform one or more functions and/or provide one or more services. In some embodiments, the software data 114 includes one or more software modifications and/or identifiers, such as file names and locations, for accessing and observing one or more software modifications. In some embodiments, the software data 114 includes an association between a software program and/or software modification and development flow data 106, such as a development flow data object. In some embodiments, the software data 114 includes an association between a software program and one or more test case data objects 105. In some embodiments, the software data 114 includes one or more service-level agreements (SLAs) associated with a software program. In some embodiments, the software data 114 includes test performance data associated with one or more testing operations performed for a software modification.

In some embodiments, the software data 114 includes one or more change request data objects indicative of software modifications. The change request data object may define a request to apply a software modification to a software program, which may include performing one or more testing operations for the software modification. In some embodiments, the change request data object includes a requested time at which to perform a testing operation for a software modification. For example, the change request data object may include a date and/or a duration of a testing operation for a software modification. In some embodiments, the change request data object includes one or more risk parameters that indicate, or from which may be determined, a risk level. In some embodiments, the change request data object includes an indication of one or more services associated with or impacted by a software modification. In some embodiments, the change request data object includes a description of one or more risks associated with applying the software modification to the software program and one or more risks associated with not applying the software modification to the software program. In some embodiments, the change request data object includes a status that can be configured to one or more states respective to the software modification. Non-limiting examples of the status may include awaiting implementation, awaiting testing, awaiting administrator approval, test failure, test pass, and/or the like.

In some embodiments, the change request data object includes or indicates a product type associated with the software modification or corresponding software program. The product type may indicate an association between the software program to be modified and a computing environment in which the software program is implemented (e.g., a computing platform or service) or one or more functions provided by the computing environment via use of the software program. For example, the product type may indicate a particular software as a service (SaaS) or on-premises computing environment with which the software program is associated. In some embodiments, the change request data object includes a priority level of applying the software modification to the corresponding software program and/or performing a testing operation for the software modification. For example, the change request data object may indicate a date by which the software modification must be applied or tested, such as a software program release date.

In some embodiments, the testing environment 103 and/or computing devices 111 is/are communicable with the modification management system 101. In some embodiments, the modification management system 101, the modification management apparatus 200, the computing devices 111, and/or the testing environment 103 are communicable over one or more communications network(s), for example the communications network(s) 118.

It should be appreciated that the communications network 118 in some embodiments is embodied in any of a myriad of network configurations. In some embodiments, the communications network 118 embodies a public network (e.g., the Internet). In some embodiments, the communications network 118 embodies a private network (e.g., an internal, localized, and/or closed-off network between particular devices). In some other embodiments, the communications network 118 embodies a hybrid network (e.g., a network enabling internal communications between particular connected devices and external communications with other devices). The communications network 118 in some embodiments may include one or more base station(s), relay(s), router(s), switch(es), cell tower(s), communications cable(s) and/or associated routing station(s), and/or the like. In some embodiments, the communications network 118 includes one or more user-controlled computing device(s) (e.g., a user owner router and/or modem) and/or one or more external utility devices (e.g., Internet service provider communication tower(s) and/or other device(s)).

Each of the components of the system communicatively coupled to transmit data to and/or receive data from one another over the same or different wireless or wired networks embodying the communications network 118. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 118, the various embodiments are not limited to this particular architecture. In other embodiments, one or more computing entities share one or more components, hardware, and/or the like, or otherwise are embodied by a single computing device such that connection(s) between the computing entities are over the communications network 118 are altered and/or rendered unnecessary.

The computing device 111 includes one or more computing device(s) accessible to an end user. In some embodiments, the computing device 111 includes a personal computer, laptop, smartphone, tablet, Internet-of-Things enabled device, smart home device, virtual assistant, alarm system, workstation, work portal, and/or the like. The computing device 111 may include one or more displays 115, one or more visual indicator(s), one or more audio indicator(s) and/or the like that enables output to a user associated with the computing device 111. For example, in some embodiments, the modification management system 101 transmits a notification comprising or embodying an administrator approval request, a test scheduling data object, a graphical user interface (GUI), one or more testing operations, one or more test failures, a communication bridge, one or more service-level agreement (SLA) impacts, one or more root cause corrective actions (RCCAs), one or more incident reports, and/or the like. In some embodiments, the computing device 111 includes one or more input devices 116 for receiving user inputs, such as commands to generate and transmit a change request data object. In some embodiments, the input device 116 include one or more buttons, cursor devices, touch screens, including three-dimensional-or pressure-based touch screens, camera, finger print scanners, accelerometer, retinal scanner, gyroscope, magnetometer, and/or other input devices. In some embodiments, two or more computing devices 111 are configured to communicate using a communication bridge generated by the modification management system 101.

In some embodiments, the modification management system 101 receives, from a computing device 111, a change request data object indicative of a software modification. In some embodiments, the modification management system 101 generates a risk level of the software modification based on the change request data object. The change request data object may indicate a downtime metric associated with the software modification, or a testing operation for the software modification, and the modification management system 101 may generate the risk level based on the downtime metric. In some embodiments, the modification management system 101 compares the risk level to one or more risk thresholds. In some embodiments, in response to determining the risk level of the software modification exceeds the risk threshold, the modification management system 101 flags the change request data object for administrator approval. In some embodiments, the modification management system 101 provides an administrator approval request to a computing device 111, such as an administrator computing device, based on the development flow data 106 associated with the software modification and/or software program being modified. The administrator approval request may indicate the change request data object and/or risk level. In some embodiments, the modification management system 101 receives, from the computing device 111, an approval of the change request data object and, in response, generates a test scheduling data object. In some embodiments, the modification management system 101 receives, from the computing device 111, a denial of the change request data object and, in response, denies the change request data object, which may include providing a notification to the computing device 111 from which the change request data object was received.

In some embodiments, the modification management system 101 generates a test scheduling data object based on the change request data object and the risk level of the software modification. The test scheduling data object may indicate one or more testing operation for the software modification. In some embodiments, the modification management system 101 modifies a distributed scheduling data object based on the test scheduling data object. In some embodiments, modification management system 101 provides a notification indicative of the test scheduling data object and/or the modified distributed scheduling data object to one or more computing devices 111 based on the development flow data 106. In some embodiments, the modification management system 101 provides a graphical user interface (GUI) indicative of the distributed scheduling data object to a plurality of computing devices 111 based on the development flow data 106. In some embodiments, the modification management system 101 causes rendering of the test scheduling data object on the GUI (e.g., within a rendering of the distributed scheduling data object) in one of a plurality of colors based on the risk level of the software modification.

In some embodiments, the modification management system 101 initiates performance of the testing operation at a testing environment 103. The testing operation may include one or more test case data objects 105. In some embodiments, the modification management system 101 provides a notification indicative of the testing operation to one or more computing devices 111 based on development flow data 106, such as a development flow data object that indicates associations between user accounts 104 and/or computing devices 111 and the software modification or software program being tested. In some embodiments, the modification management system 101 receives, from the testing environment 103, test performance data. In some embodiments, the modification management system 101 determines one or more test failures based on the test performance data. In some embodiments, in response to determining the test failure, the modification management system 101 generates a communication bridge between a subset of a plurality of computing devices 111 associated with the software program and/or software modification based on the test failure and development flow data 106, such as a development flow data object indicative of associations between user accounts 104, the software modification, and the software program being modified. In some embodiments, the modification management system queries the development flow data 106 based on the test failure to determine the subset of the plurality of computing devices 111. In some embodiments, to generate the communication bridge, the modification management system 101 generates a teleconference communication session between the subset of the plurality of computing devices 111. In some embodiments, the modification management system 101 provides a notification indicative of the communication bridge to the subset of the plurality of computing devices 111. In some embodiments, the modification management system 101 generates a second test scheduling data object based on the communication bridge and/or test failure and modifies the distributed scheduling data object based on the second test scheduling data object.

In some embodiments, the modification management system 101 automatically, or in response to input from a computing device 111, modifies a status of the change request data object based on the test failure, such as to indicate the test failure. In some embodiments, the modification management system 101 modifies the test scheduling data object and/or distributed scheduling data object based on the test failure and/or modified status of the change request data object. In some embodiments, the modification management system 101 generates, based on the test failure, one or more correction data objects indicative of one or more service level agreement (SLA) impacts determined based on the test failure and/or test performance data. In some embodiments, the modification management system 101 performs one or more root cause corrective actions (RCCAs) on the software modification based on the correction data object (e.g., to adjust the software modification to mitigate the one or more SLA impacts). In some embodiments, the modification management system 101 generates, using one or more models 112, one or more test case corrections based on the test failure. In some embodiments, the modification management system 101 applies the test case correction to the corresponding test case data object. In some embodiments, the modification management system 101 generates an incident report based on the test failure and/or test performance data. In some embodiments, the modification management system provides the incident report to one or more computing devices 111 based on the development flow data 106.

FIG. 2 illustrates a block diagram of an example apparatus that may be specially configured in accordance with at least some example embodiments of the present disclosure; Specifically, FIG. 2 depicts an example modification management apparatus 200 (“apparatus 200”) specially configured in accordance with at least some example embodiments of the present disclosure. In some embodiments, the modification management system 101 and/or a portion thereof is embodied by one or more system(s), such as the apparatus 200 as depicted and described in FIG. 2. The apparatus 200 includes processor 201, memory 203, communications circuitry 205, input/output circuitry 207, data intake circuitry 209, data processing circuitry 211, data analysis circuitry 213, and optional testing circuitry 215. In some embodiments, the apparatus 200 is configured, using one or more of the processor 201, memory 203, communications circuitry 205, input/output circuitry 207, data intake circuitry 209, data processing circuitry 211, data analysis circuitry 213, and/or testing circuitry 215 to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Additionally, or alternatively, in some embodiments, other elements of the apparatus 200 provide or supplement the functionality of another particular set of circuitry. For example, the processor 201 in some embodiments provides processing functionality to any of the sets of circuitry, the memory 203 provides storage functionality to any of the sets of circuitry, the communications circuitry 205 provides network interface functionality to any of the sets of circuitry, and/or the like.

In some embodiments, the processor 201 (and/or co-processor or any other processing circuitry assisting or otherwise associated with the processor) is/are in communication with the memory 203 via a bus for passing information among components of the apparatus 200. In some embodiments, for example, the memory 203 is non-transitory and may include, for example, one or more volatile and/or non-volatile memories. In other words, for example, the memory 203 in some embodiments includes or embodies an electronic storage device (e.g., a computer readable storage medium). In some embodiments, the memory 203 is configured to store information, data, content, applications, instructions, or the like, for enabling the apparatus 200 to carry out various functions in accordance with example embodiments of the present disclosure. In some embodiments, the memory 203 is embodied as, or communicates with, a data store 102 as shown in FIG. 1 and described herein.

The processor 201 may be embodied in a number of different ways. For example, in some example embodiments, the processor 201 includes one or more processing devices configured to perform independently. Additionally, or alternatively, in some embodiments, the processor 201 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 201 is configured to execute instructions stored in the memory 203 or otherwise accessible to the processor. Additionally, or alternatively, the processor 201 in some embodiments is configured to execute hard-coded functionality. As such, whether configured by hardware or software methods, or by a combination thereof, the processor 201 represents an entity (e.g., physically embodied in circuitry) capable of performing operations according to an embodiment of the present disclosure while configured accordingly. Additionally, or alternatively, as another example in some example embodiments, when the processor 201 is embodied as an executor of software instructions, the instructions specifically configure the processor 201 to perform the algorithms embodied in the specific operations described herein when such instructions are executed.

As one particular example embodiment, the processor 201 is configured to perform various operations associated with automating management of software modifications, including receiving change request data objects, generating risk levels, generating test scheduling data objects, modifying distributed data scheduling objects, generating notifications, providing notifications and/or graphical user interfaces (GUIs) to computing devices 111, initiating performances of testing operations, obtaining test performance data, generating communication bridges, determining test failures, generating test case corrections, applying test case corrections, determining service-level agreement (SLA) impacts, performing root cause corrective actions (RCCAs), and generating incident reports. In some embodiments, the processor 201 includes hardware, software, firmware, and/or a combination thereof, that receives change request data objects, test performance data, and potentially other data. Additionally, or alternatively, in some embodiments, the processor 201 includes hardware, software, firmware, and/or a combination thereof, that determine a test failure based on test performance data. Additionally, or alternatively, in some embodiments, the processor 201 includes hardware, software, firmware, and/or a combination thereof, that generates a communication bridge between two or more computing devices 111 based on a development flow data object.

In some embodiments, the apparatus 200 includes input/output circuitry 207 that provides output to the user and, in some embodiments, to receive an indication of a user input. For example, the input/output circuitry 207 provides output to and receives input from one or more computing devices (e.g., computing devices 111 shown in FIG. 1 and described herein). In one example, the input/output circuitry 207 receives an administrator input for approving or denying a change request data object. In another example, the input/output circuitry 207 receives one or more user inputs that define a change request data object. In some embodiments, the input/output circuitry 207 is in communication with the processor 201 to provide such functionality. The input/output circuitry 207 may comprise one or more user interface(s) and in some embodiments includes a display that comprises the interface(s) rendered as a web user interface, an application user interface, a user device, a backend system, or the like. In some embodiments, the input/output circuitry 207 also includes a keyboard, a mouse, a joystick, a touch screen, touch areas, soft keys a microphone, a speaker, and/or other input/output mechanisms. The processor 201 and/or input/output circuitry 207 comprising the processor may be configured to control one or more functions of one or more user interface elements through computer program instructions (e.g., software and/or firmware) stored on a memory accessible to the processor (e.g., memory 203, and/or the like). In some embodiments, the input/output circuitry 207 includes or utilizes a user-facing application to provide input/output functionality to a computing device and/or other display associated with a user.

In some embodiments, the apparatus 200 includes communications circuitry 205. The communications circuitry 205 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 205 includes, for example, a network interface for enabling communications with a wired or wireless communications network, such as the network 118 shown in FIG. 1 and described herein. Additionally, or alternatively in some embodiments, the communications circuitry 205 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 205 includes circuitry for interacting with the antenna(s) and/or other hardware or software to cause transmission of signals via the antenna(s) or to handle receipt of signals received via the antenna(s). In some embodiments, the communications circuitry 205 enables transmission to and/or receipt of data from computing devices (e.g., such as computing devices 111), testing environments (e.g., such as testing environment 103), and/or other external computing devices in communication with the apparatus 200. In some embodiments, the communications circuitry 205 enables generation of communication bridges between computing devices (e.g., such as a plurality of computing devices 111). In some embodiments, the communications circuitry 205 enables initiation of one or more testing operations at a testing environment or via the optional testing circuitry 215.

The data intake circuitry 209 includes hardware, software, firmware, and/or a combination thereof, that supports receiving data associated with automated management of software modifications, such as software data, risk data, scheduling data, or development flow data. For example, in some embodiments, the data intake circuitry 209 includes hardware, software, firmware, and/or a combination thereof, that captures and/or receives test performance data associated with one or more testing operations and test case data objects from a testing environment (e.g., such as testing environment 103). The data intake circuitry 209 may communicate with a testing environment to receive such test performance data. The data intake circuitry 209 may communicate with computing devices (e.g., such as computing devices 111) to provide notifications, provide incident reports, receive change request data objects (e.g., or inputs for defining a change request data object), and/or receive responses to administrator approval requests. Additionally, or alternatively, in some embodiments, the data intake circuitry 209 includes hardware, software, firmware, and/or a combination thereof, that requests risk parameters for a software modification from one or more computing devices and receives the risk parameters in response. Additionally, or alternatively, in some embodiments, the data intake circuitry 209 includes hardware, software, firmware, and/or a combination thereof, that maintains one or more data store(s) including user accounts, development flow data, risk data, scheduling data, and software data. In some embodiments, data intake circuitry 209 includes a separate processor, specially configured field programmable gate array (FPGA), and/or a specially programmed application specific integrated circuit (ASIC).

The data processing circuitry 211 includes hardware, software, firmware, and/or a combination thereof, that supports various functionality associated with automatically managing software modifications, including processing change request data objects, test performance data, responses to administrator approval requests, scheduling data, development flow data objects, or service-level agreements (SLAs). For example, in some embodiments, the data processing circuitry 211 includes hardware, software, firmware, and/or any combination thereof, that determines an outcome of a testing operation, such as a test failure, based on test performance data. In another example, in some embodiments, the data processing circuitry 211 includes hardware, software, firmware, and/or any combination thereof, that processes a change request data object to obtain one or more risk parameters. In another example, in some embodiments, the data processing circuitry 211 includes hardware, software, firmware, and/or any combination thereof, that determines a subset of a plurality of computing devices to provide a notification or incident report based on development flow data. Additionally, or alternatively, in some embodiments, the data processing circuitry 211 includes hardware, software, firmware, and/or any combination thereof, that determines a distributed scheduling object associated with a plurality of user accounts or computing devices based on development flow data. In some embodiments, the data processing circuitry includes hardware, software, firmware, and/or any combination thereof, that modifies a distributed scheduling data object based on a test scheduling data object. In some embodiments, the data processing circuitry includes hardware, software, firmware, and/or any combination thereof, that generates a test scheduling data object based on a change request data object and/or risk level of a software modification. In some embodiments, the data processing circuitry includes hardware, software, firmware, and/or any combination thereof, that generates graphical user interfaces (GUIs) indicative of distributed scheduling data objects, test scheduling data objects, incident reports, and/or the like. In some embodiments, the data processing circuitry includes hardware, software, firmware, and/or any combination thereof, that modifies a status of a change request data object based on a test failure. In some embodiments, the data processing circuitry includes hardware, software, firmware, and/or any combination thereof, that generates an incident report based on a test failure and/or test performance data. In some embodiments, the data processing circuitry 211 includes a separate processor, specially configured field programmable gate array (FPGA), and/or a specially programmed application specific integrated circuit (ASIC).

The data analysis circuitry 213 includes hardware, software, firmware, and/or a combination thereof, that supports various functionality associated with automatically managing software modifications, including generating a risk level of a software modification, determining whether a risk level exceeds a risk threshold, flagging a change request data object based on a risk level of an associated software modification, generating an administrator approval request, generating correction data objects indicative of service-level agreement (SLA) impacts, and determining root cause corrective actions (RCCAs). In some embodiments, the data analysis circuitry 213 includes hardware, software, firmware, and/or a combination thereof, that generates a risk level of a software modification. For example, the data analysis circuitry 213 may generate a risk level of a software modification based on one or more risk parameters indicated by a change request data object, and potentially other data, such as a distributed scheduling data object or SLA. Additionally, or alternatively, in some embodiments, the data analysis circuitry 213 includes hardware, software, firmware, and/or a combination thereof, that compares a risk level to a risk threshold and outputs a corresponding indicator that represents whether the risk level exceeds the risk threshold. In some embodiments, the data analysis circuitry 213 includes hardware, software, firmware, and/or a combination thereof, that determines a risk category based on the risk level, which may include determining one of a plurality of colors in which to render a test scheduling data object within a GUI based on the risk category.

In some embodiments, the data analysis circuitry 213 includes hardware, software, firmware, and/or a combination thereof, that generates a correction data object based on a test failure and/or test performance data, where the correction data object indicates one or more SLA impacts. In some embodiments, the data analysis circuitry 213 includes hardware, software, firmware, and/or a combination thereof, that generates test case corrections based on a test failure and/or test performance data. For example, in some embodiments, the data analysis circuitry 213 includes hardware, software, firmware, and/or a combination thereof, that supports various functionality associated with accessing and executing models described herein for generating correction data objects or test case corrections (e.g., such as models 112). In some embodiments, the data analysis circuitry 213 includes hardware, software, firmware, and/or a combination thereof, that apply a test case correction to a test case data object. In some embodiments, the data analysis circuitry 213 includes a separate processor, specially configured field programmable gate array (FPGA), and/or a specially programmed application specific integrated circuit (ASIC).

The optional testing circuitry 215 includes hardware, software, firmware, and/or a combination thereof, that supports various functionality associated with automatically performing testing operations for a software modification. In some embodiments, the testing circuitry 215 performs functions elsewhere described herein as being performed by a testing environment, such as the testing environment 103. In some embodiments, the testing circuitry 215 includes hardware, software, firmware, and/or a combination thereof, that supports various functionality associated with performing testing operations for software modifications. In some embodiments, the testing circuitry 215 includes hardware, software, firmware, and/or a combination thereof, that supports various functionality associated with testing performance of a software program, modified by a software modification, in one or more testing operations according to one or more test case data object (e.g., test case data objects 105). In some embodiments, the testing circuitry 215 includes a separate processor, specially configured field programmable gate array (FPGA), and/or a specially programmed application specific integrated circuit (ASIC).

Additionally, or alternatively, in some embodiments, two or more of the processor 201, memory 203, communications circuitry 205, input/output circuitry 207, data intake circuitry 209, data processing circuitry 211, data analysis circuitry 213, and/or testing circuitry 215 are combinable. Additionally, or alternatively, in some embodiments, one or more of the sets of circuitry perform some or all of the functionality described associated with another component. For example, in some embodiments, two or more of the sets of circuitry 201-215 are combined into a single module embodied in hardware, software, firmware, and/or a combination thereof. Similarly, in some embodiments, one or more of the sets of circuitry, for example the data intake circuitry 209, the data processing circuitry 211, the data analysis circuitry 213, and/or the testing circuitry 215 is/are combined with the processor 201, such that the processor 201 performs one or more of the operations described above with respect to each of these sets of circuitry 207-215.

### EXAMPLE DATA FLOWS AND DATA ARCHITECTURES OF THE DISCLOSURE

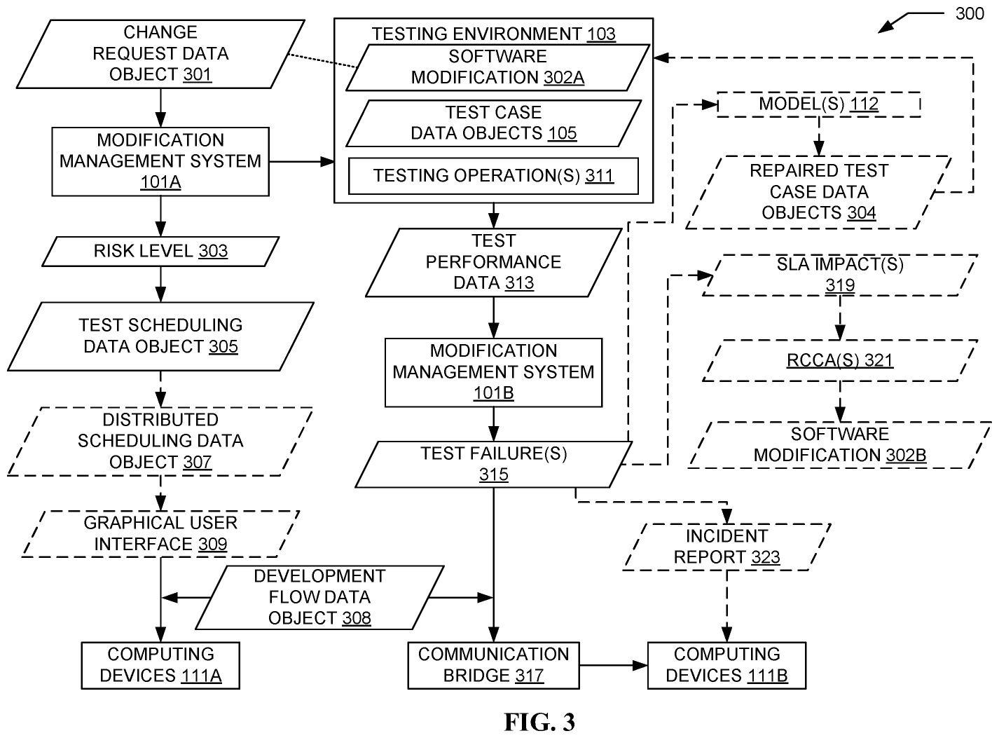

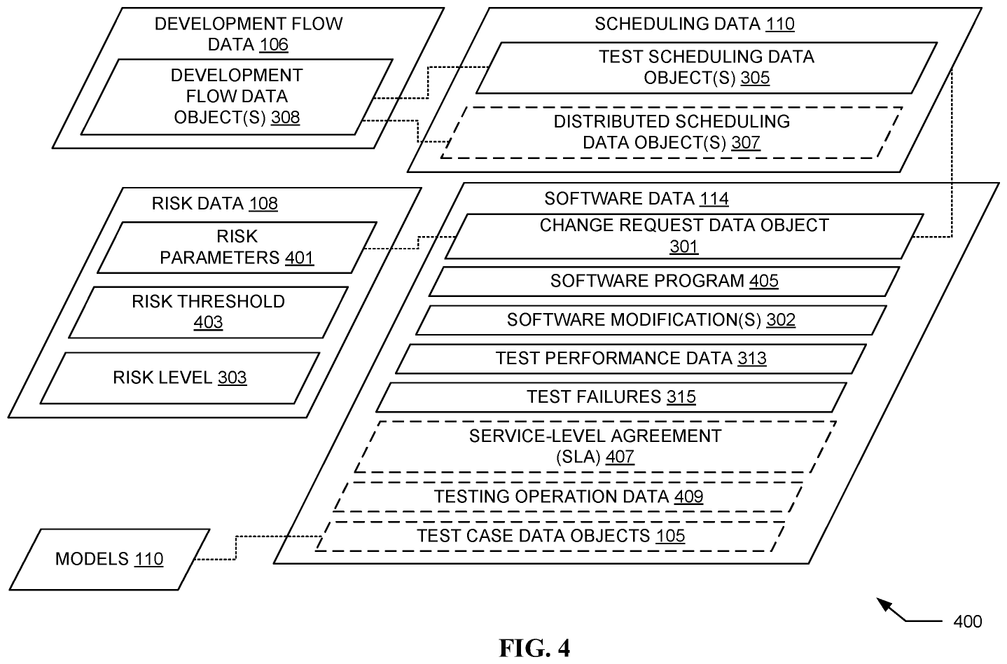

Having described example systems and apparatuses in accordance with embodiments of the present disclosure, example data flows and architectures of data in accordance with the present disclosure will now be discussed. In some embodiments, the systems and/or apparatuses described herein maintain data environment(s) that enable the data flows in accordance with the data architectures described herein. For example, in some embodiments, the systems and/or apparatuses described herein function in accordance with the data flow depicted in FIG. 3, and the data flows and data architectures depicted and/or described with respect to FIG. 4 are performed or maintained via the modification management system 101 embodied by an apparatus 200 and/or a testing environment 103.

FIG. 3 illustrates an example data flow 300 in accordance with at least some example embodiments of the present disclosure. Specifically, FIG. 3 depicts a flow of data between the various computing devices depicted and described in FIG. 1.

As illustrated, in some embodiments, the data flow 300 includes the modification management system 101A, 101B receiving a change request data object 301. For example, the modification system 101A, 101B may receive the change request data object 301 from a computing device, such as a computing device 111. In some embodiments, the change request data object 301 indicates a software modification 302A. In some embodiments, the change request data object 301 indicates a software program to be modified by the software modification 302A.

In some embodiments, the data flow 300 includes the modification management system 101A, 101B determining a risk level 303 of the software modification 302A based on the change request data object 301. In some embodiments, the data flow 300 optionally includes the modification management system 101A. 101B determining whether the risk level 303 exceeds a risk threshold. In some embodiments, the data flow 300 optionally includes the modification management system 101A, 101B flagging the change request data object 301 for administrator approval in response to determining the risk level 303 exceeds the risk threshold. In some embodiments, the data flow 300 optionally includes the modification management system 101A, 101B providing an administrator approval request to a computing device, such as a computing device associated with an administrator user account, based on a development flow data object 308. In some embodiments, the data flow 300 optionally includes the modification management system 101A, 101B receiving a user input indicative of an approval or denial of the change request data object 301 from the computing device. In some embodiments, the data flow 300 optionally includes the modification management system 101A, 101B denying the change request data object 301 in response to receiving a user input indicative of a denial, which may include the modification management system 101A, 101B providing a notification indicative of the denial to a computing device from which the change request data object 301 was received. In some embodiments, the data flow 300 optionally includes the modification management system 101A, 101B proceeding with initiating a test operation of the software modification 302A in response to receiving a user input indicative of an approval of the change request data object 301.

In some embodiments, the data flow 300 includes the modification management system 101A, 101B generating a test scheduling data object 305 based on the change request data object 301, the risk level 303 of the software modification 302A, and potentially other data, such as the development flow data object 308 or one or more personal scheduling data objects (e.g., digital calendars) associated with one or more user accounts indicated by the development flow data object 308. In some embodiments, the test scheduling data object 305 is indicative of one or more testing operations 311 for the software modification 302A.

In some embodiments, the data flow 300 optionally includes the modification management system 101A, 101B modifying a distributed scheduling data object 307 based on the test scheduling data object 305. In some embodiments, the data flow 300 optionally includes the modification management system 101A, 101B providing a notification indicative of the change request data object, the test scheduling data object 305, and/or the distributed scheduling data object to one or more computing devices based on the development flow data object 308.

In some embodiments, the data flow 300 optionally includes the modification management system 101A, 101B providing a graphical user interface (GUI) 309 indicative of the distributed scheduling object 307 to one or more computing devices 111A based on a development flow data object 308. In some embodiments, the data flow 300 optionally includes the modification management system 101A, 101B causing rendering of the GUI 309 on a display of the computing device 111A. In some embodiments, the GUI 309 includes a rendering of the distributed scheduling data object 307 including the test scheduling data object 305. In some embodiments, the data flow 300 includes the modification management system 101A, 101B causing the test scheduling data object 307 to be rendered on the GUI 309 in a particular color based on the risk level 303 and/or a risk category determined based on the risk level 303 and one or more risk thresholds.

In some embodiments, the data flow 300 includes the modification management system 101A, 101B initiating performance of one or more testing operations 311 for the software modification 302A at a testing environment 103. In some embodiments, the data flow 300 includes the modification management system 101A, 101B causing the testing environment to perform the testing operation 311 for the software modification 302A based on one or more test case data objects 105. In some embodiments, the data flow 300 optionally includes the modification management system 101A, 101B providing a notification indicative of the testing operation 311 to one or more computing devices based on the development flow data object 308.

In some embodiments, the data flow 300 includes the modification management system 101A, 101B receiving test performance data 313 from the testing environment 103. In various embodiments, the test performance data 313 facilitates determination of whether a modified software program satisfied one or more software program objectives (e.g., exercising a particular software program path, providing an intended function, operating at requisite speed, stability, efficiency, and/or the like). In some embodiments, the test performance data 313 includes output generated by the modified software program during the testing operation. Additionally, or alternatively, in some embodiments, the test performance data 313 includes an input and/or intermediary data constructs based upon which the modified software program generated the output. Additionally, or alternatively, in some embodiments, the test performance data 313 includes one or more metrics that define a performance level of the modified software program. For example, in some contexts, the test performance data 313 includes a processing time, latency metric, throughput metric, average response time, average que time, error rate, request rate, central processing unit (CPU) usage, memory usage, virtual users per unit of time, peak response time, peak concurrent virtual users, and/or the like.

In some embodiments, the data flow 300 includes the modification management system 101A, 101B determining one or more test failures 315 based on the test performance data 313. In some embodiments, the data flow 300 optionally includes the modification management system 101A, 101B generating, using one or more models 112, one or more test case corrections based on the test failure 315 and/or the test performance data 313. In some embodiments, the data flow 300 optionally includes the modification management system 101A, 101B applying the test correction to one or more test case data objects 105 to generate one or more repaired test case data objects 304. In some embodiments, the data flow 300 optionally includes the modification management system 101A, 101B providing the one or more repaired test case data objects 304 to the testing environment 103. In some embodiments, the data flow 300 optionally includes the modification management system 101A, 101B modifying a status of the change request data object 301 based on the test failure 315 and/or test performance data 313. In some embodiments, the data flow 300 optionally includes the modification management system 101A, 101B providing a notification indicative of the test failure 315 to one or more computing devices 111B based on the development flow data object 308.

In some embodiments, the data flow 300 includes the modification management system 101A, 101B generating a communication bridge 317 between a plurality of computing devices 111B based on the development flow data object 308 and/or test failure 315. In some embodiments, the data flow 300 optionally includes the modification management system 101A, 101B generating a teleconference communication session between the plurality of computing devices 111B, where the teleconference communication session may embody the communication bridge 317. In some embodiments, the data flow 300 optionally includes the modification management system 101A. 101B providing a notification indicative of the communication bridge 317 to the plurality of computing devices 111B. In some embodiments, the data flow 300 optionally includes the modification management system 101A, 101B generating a second test scheduling data object, modifying the distributed scheduling data object 307 based on the second test scheduling data object, and/or providing a notification indicative of the second test scheduling data object and/or distributed scheduling data object 307 to the plurality of computing devices 111B.

In some embodiments, the data flow 300 optionally includes the modification management system 101A, 101B generating a correction data object indicative of one or more service-level agreement (SLA) impacts 319 based on the test failure 315 and/or test performance data 313. In some embodiments, the data flow 300 optionally includes the modification management system 101A, 101B determining one or one or more root cause corrective actions (RCCAs) 321 based on the correction data object. In some embodiments, the data flow 300 optionally includes the modification management system 101A, 101B performing the RCCA 321 on the software modification 302A to generate a software modification 302B (e.g., in which the SLA impact 319 may be mitigated). In some embodiments, the data flow 300 optionally includes the modification management system 101A, 101B generating an incident report 323 based on the test failure 315 and/or test performance data 313. In some embodiments, the data flow 300 optionally includes the modification management system 101A, 101B providing the incident report 323 to one or more computing devices 111B based on the development flow data object 308. In some embodiments, the data flow 300 optionally includes the modification management system 101A, 101B initiating performance of a plurality of testing operations 311 for the software modification 302 and determining an outcome of each of the plurality of testing operations based on associated test performance data 313. In some embodiments, the data flow 300 optionally includes the modification management system 101A, 101B generating an incident report 323 based on the outcome of each of the plurality of testing operations 311. In some embodiments, the data flow 300 optionally includes the modification management system 101A, 101B providing the incident report 323 to the plurality of computing devices 111B based on the development flow data object 308. In some embodiments, the incident report 323 indicates, from the plurality of testing operations 311, a quantity of passed testing operations, a quantity of skipped testing operations, and a quantity of failed testing operations.

FIG. 4 illustrates an example data architecture 400 in accordance with at least some example embodiments of the present disclosure. Specifically, FIG. 4 illustrates a data architecture 400 for a portion of development flow data, risk data, scheduling data, and software data in accordance with at least some embodiments of the present disclosure. In this regard, any development flow data, risk data, scheduling data, and/or software data received, transmitted, generated, and/or otherwise manipulated via the systems described herein may be architected in accordance with the depicted data architecture to include the particular data values therein. The development flow data, risk data, scheduling data, software data, and contents thereof, shown in FIG. 4 and described herein are exemplary in nature, non-exhaustive and are provided to illustrate and describe exemplary aspects of the present systems and processes according to various embodiments.

As illustrated, the development flow data 106 may include one or more development flow data objects 308. In some embodiments, the development flow data object 308 defines associations between a software program 405 (e.g., and/or a software modification 302) and software program stakeholders, such as user accounts 104 (FIG. 1), and/or computing devices associated with software program stakeholders. In some embodiments, the development flow data object 308 indicates responsibilities, purviews, duties, and/or the like of user accounts associated with the software program 405. In some embodiments, the development flow data object 308 indicates portions or aspects of the software program 405 for which one or more user accounts are responsible. In some embodiments, the development flow data object 308 indicates associations between test case data objects 105 and user accounts. In some embodiments, the development flow data object 308 indicates associations between the software program 405 and one or more service-level agreements (SLAs) 407.

As illustrated, the risk data 108 may include risk parameters 401, one or more risk thresholds 403, and one or more risk levels 303. In some embodiments, the risk level 303 is associated with a particular software modification and/or software program 405. In some embodiments, the risk parameters 401 are associated with a particular change request data object 301 (e.g., a change request data object from which the risk parameters 401 were obtained). In some embodiments, the risk parameters 401 indicate whether the software modification is associated with a critical service or functionality of a computing environment, whether the software modification impacts additional services or functionalities (e.g., such as upstream or downstream services or functionalities respective to a service or functionality embodied by the software program to be modified), a level of downtime estimated for performing a testing operation for the software modification, and/or the like.

In some embodiments, the risk level 303 defines a predicted impact of performing a testing operation for a software modification 302. In some embodiments, the impact includes a predicted amount of downtime for a computing environment, such as a computing platform or service, or a predicted time period of unavailability of one or more functions provided by the computing environment. In some embodiments, the risk level embodies one or more risk categories respective to performing a testing operation for the software modification 302, or a status of the testing operation. For example, the risk category may include critical risk, high risk, medium risk, low risk, no or unspecified risk, cancelled testing operation, and/or the like. In some embodiments, each risk level 303 is associated with one of a plurality of colors such that a risk level of a software modification 302, or associated testing operation, may be indicated in a display of a test scheduling data object 305 and/or distributed scheduling data object 307 based on a rendered color. For example, a critical risk level 303 may be associated with a red color, a high risk level 303 may be associated with a yellow color, a medium risk level 303 may be associated with a light blue color, a low risk level 303 may be associated with a green color, a no or unspecified risk level 303 may be associated with a grey color, and a cancelled testing operation may be associated with a black color. In some embodiments, the risk threshold 403 is associated with a risk category. For example, each of the preceding example risk levels 303, risk categories, and associated colors may be defined based on a value, or range of values, indicated by a risk threshold 403.

In some embodiments, the risk threshold 403 defines a maximum risk level at or above which a change request data object may be flagged for administrator approval, which may include providing an administrator approval request to an administrator user account or administrator computing device. In one example, a risk threshold 403 may include a maximum downtime, such as 1 hour, 2 hours, or any suitable interval, for performing one or more testing operations for the software modification 302. In another example, a risk threshold may include a maximum number of computing environment services or functions that may be impacted during performance of a testing operation for the software modification 302.

As illustrated, the scheduling data 110 may include one or more test scheduling data objects 305 and one or more distributed scheduling data objects 307, either or both of which may be associated with a development flow data object 308 and/or change request data object 301. In some embodiments, the test scheduling data object 305 defines a time period or interval for performing an action, such as one or more testing operations. In one example, a test scheduling data object 305 may include an entry for a digital calendar that includes a date and a duration of a testing operation for the software modification 302. In some embodiments, the test scheduling data object 305 is associated with one or more user accounts. For example, a test scheduling data object 305 may be an entry to a particular digital calendar associated with a particular user account. In some embodiments, the distributed scheduling data object 307 is a scheduling data object accessible by and/or provided to a plurality of user accounts and/or computing devices. For example, a distributed scheduling data object 307 may include a collaborative digital calendar accessible by a plurality of members of a software development team. In some embodiments, the distributed scheduling data object 307 includes a graphical user interface (GUI) configured to receive user inputs. For example, the distributed scheduling data object 307 may include a GUI configured to receive one or more user inputs for generating and configuring a change request data object 301.

As illustrated, the software data 114 may include one or more change request data objects 301, one or more software programs 405, one or more software modifications 302, test performance data 313, data indicative of test failures 315, service-level agreements (SLAs) 407, testing operation data 409, and one or more test case data objects 105. In some embodiments, the change request data object 301 301 defines a request to apply a software modification 302 to a software program 405, which may include performing one or more testing operations for the software modification. In some embodiments, the change request data object 301 indicates or includes the software modification 302. In some embodiments, the change request data object 301 includes a requested time at which to perform a testing operation for the software modification 302. For example, the change request data object 301 may include a date and/or a duration of a testing operation for the software modification 302. In some embodiments, the change request data object 301 indicates the one or more risk parameters 401. In some embodiments, the change request data object 301 includes an indication of one or more services associated with or impacted by the software modification 302. In some embodiments, the change request data object 301 includes a description of one or more risks associated with applying the software modification 302 to the software program 405 and one or more risks associated with not applying the software modification 302 to the software program 405. In some embodiments, the change request data object 301 includes or indicates a product type associated with the software modification 302 or corresponding software program 405. The product type may indicate an association between the software program 405 a computing environment in which the software program 405 is implemented (e.g., a computing platform or service) or one or more functions provided by the computing environment via use of the software program 405.

In some embodiments, the software program 405 is any operating information used by a computer or computing network. For example, the software program 405 may include program code executable by logic circuitry of one or more computing devices, such as a server processor. In some embodiments, the software modification 302 is a change to the software program 405. For example, the software modification 302 may include a change to program code that defines the software program 405. In some embodiments, the test performance data 313 includes data associated with or generated by the software program 405 during performance of a testing operation. In some embodiments, the test performance data 313 includes or indicates an outcome of one or more testing operations and/or test case data objects. For example, test performance data 313 may include outputs generated by the software program 405 during a testing operation, one or more comparisons between the outputs and one or more expected outputs, one or more metrics associated with generating the outputs (e.g., runtime, stability, etc.), and/or the like. In some embodiments, the test performance data 313 includes data indicative of whether the software program 405 passed, failed, or skipped one or more test case data objects during performance of a testing operation. In some embodiments, the test performance data 313 includes one or more specification files that indicate or summarize performance of the software program 405 and/or software modification 302 in one or more testing operations.

In some embodiments, the test failure 315 comprises data indicative of an instance in which the software program 405 generates an output that deviates from an expected output and/or was generated outside of a predetermined interval, either or both of which may be defined by testing operation data 409 and/or one or more test case data objects 105. For example, the test failure 315 may include the output generated by the software program 405 during performance of a testing operation. In some embodiments, the test failure 315 includes the expected output of the failed test operation. In some embodiments, the test failure 315 includes one or more SLA impacts associated with failure of the corresponding testing operation.

In some embodiments, the SLA 407 defines expectations of the software program 405 between a provider or creator of the software program 405 and a customer for the software program 405. For example, the SLA 407 may describe products or services to be delivered, one or more points of contact for end-user problems, and one or more metrics by which the performance of the software program 405 is assessed and approved. In some embodiments the testing operation data 409 defines one or more testing operations. For example, the testing operation data 409 includes one or more test case data objects 105. In some embodiments, the testing operation data 409 includes historical test performance data 313 associated with one or more historical software modifications 302 and/or software programs 405. In some embodiments, the testing operation data 409 includes or indicates a storage location of one or more files used in a testing operation, such as training datasets, validation datasets, simulated graphical user interfaces (GUIs), simulated user inputs, and/or the like. In some embodiments, the test case data object 105 defines inputs, execution conditions, testing procedure, and expected results for a testing operation to be executed for the software program 405 modified by the software modification 302. In some embodiments, the test case data object 105 defines a particular software testing objective, such as to exercise a particular software program path or to verify compliance with an intended functionality. In some embodiments, the test case data object 105 defines a simulated scenario of user inputs to and expected outputs for the software program 405. For example, a test case data object 105 may define one or more user inputs and expected outputs or behaviors for a simulated graphical user interface test.

### EXAMPLE PROCESSES OF THE DISCLOSURE

Having described example systems and apparatuses, data architectures, data flows, and graphical representations in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

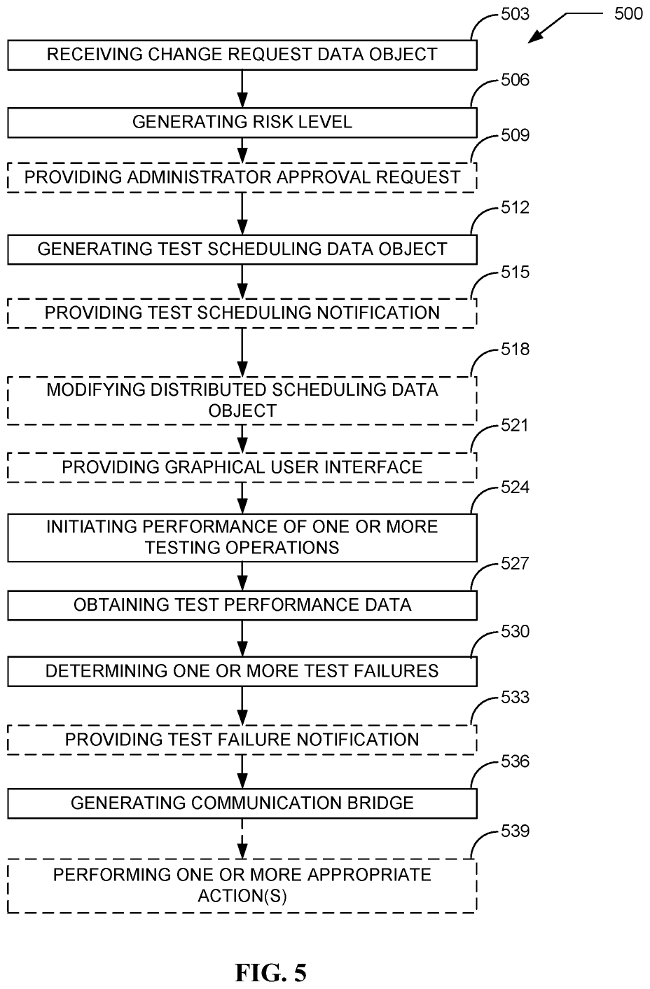

FIG. 5 illustrates a flowchart depicting operations of an example process for automating management of a software modification in accordance with at least some example embodiments of the present disclosure. Specifically, FIG. 5 depicts operations of an example process 500. In some embodiments, the process 500 is embodied by computer program code stored on a non-transitory computer-readable storage medium of a computer program product configured for execution to perform the process as depicted and described. Additionally, or alternatively, in some embodiments, the process 500 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 203 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one apparatus, one or more computing devices, and/or in some embodiments a testing environment. For purposes of simplifying the description, the process 500 is described as performed by and from the perspective of the apparatus 200. In some embodiments, the apparatus 200 initiates the process 500 in response to receiving a change request data object. In some embodiments, the apparatus 200 initiates the process 500 automatically in response to receiving a notification for an event, such as an upload of a software modification to a particular computing environment or data store.

The process 500 begins at operation 503. At operation 503, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that receive a change request data object indicative of a software modification. In some embodiments, the change request data object indicates a software program to be modified. In some embodiments, the change request data object includes risk parameters for the software modification (e.g., and/or indications of risks for applying or not applying the software modification to the software program). In some embodiments, the change request data object includes or indicates a development flow data object. In some embodiments, the apparatus 200 receives a request to generate a change request data object. For example, the apparatus 200 receives a request to generate a change request data object by receiving a selection to a graphical user interface including a distributed scheduling data object. In some embodiments, in response to the request, the apparatus 200 generates and causes rendering of one or more graphical user interfaces for receiving user inputs that define the change request data object. For example, the apparatus 200 may generate a GUI configured for receiving user inputs indicative of whether a software modification is associated with a critical service and/or impacts additional services, a downtime metric for the software modification, and other risk parameters. Additionally, or alternatively, the GUI may be configured for receiving inputs indicative of a risk of applying or not applying a software modification to a software program, a brief summary of the software modification, one or more product types associated with the software modification, a scaled priority level associated with the software modification, and/or a detailed description of the software modification.

At operation 506, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that generate a risk level of the software modification based on the change request data object. For example, the apparatus 200 may generate the risk level based on one or more risk parameters, such as an expected downtime and whether a critical service and/or additional service may be impacted by a testing operation for the software modification.

At operation 509, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that optionally provide an administrator approval request to an administrator user account, or computing device associated therewith, based on the risk level of operation 506. In some embodiments, the apparatus 200 determines that the risk level exceeds a risk threshold. For example, the apparatus 200 may compare the risk level to the risk threshold. In a particular example, the risk threshold may be a downtime of 1 hour or greater (e.g., or any suitable time variable) and the apparatus determines that the expected downtime for the software modification of 2 hours exceeds the risk threshold. In some embodiments, in response to determining the risk level exceeds the risk threshold, the apparatus 200 provides an administrator approval request to a computing device (e.g., an administrator computing device) based on a development flow data object associated with the software program to be modified and/or the software modification. In some embodiments, the administrator approval request indicates the risk level. In some embodiments, the administrator approval request indicates one or more risk parameters, such as an expected downtime for testing the software modification, whether the software modification is associated with a critical service, and/or whether the software modification impacts one or more services in addition to a service associated with the software program to be modified. In some embodiments, the apparatus 200 receives an approval of the administrator approval request from the administrator user account or the administrator computing device. In some embodiments, the approval of the administrator approval request indicates an approval to perform one or more testing operations respective to the software modification. In some embodiments, in response to the apparatus 200 receiving the approval of the administrator approval request, the process 500 proceeds to operation 512. In some embodiments, the apparatus 200 receives a denial of the administrator approval request from the administrator user account or administrator computing device. In some embodiments, in response to the apparatus 200 receiving the denial of the administrator approval request, the process 500 is suspended. In some embodiments, in response to the apparatus 200 suspending the process 500, the apparatus 200 transmits a notification to the computing device or user account from which the change request data object was received, where the notification indicates the denial for testing the software modification.

At operation 512, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that generate a test scheduling data object. In some embodiments, the apparatus 200 generates an entry for a digital calendar, where the entry includes a date and a duration of a testing operation for the software modification.

At operation 515, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that optionally provide a notification indicative of the test scheduling data object to one or more computing devices. For example, the apparatus 200 may generate a notification including a date and duration of the testing operation. The apparatus 200 may provide the notification to a subset of a plurality of computing devices based on a development flow data object, which may be indicated by or retrieved based on the change request data object. In one example, the notification includes an email which may be transmitted by the apparatus 200 to one or more computing devices (e.g., or to email accounts of user accounts determined based on the development flow data object).

At operation 518, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that optionally modify a distributed scheduling data object based on the test scheduling data object. For example, the apparatus 200 modifies a shared calendar to include an entry corresponding to the test scheduling data object.

At operation 521, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that optionally provide a graphical user interface indicative of the distributed scheduling data object to one or more computing devices. In some embodiments, the apparatus 200 renders on the GUI the test scheduling data object. The apparatus 200 may render the test scheduling data object in a particular color based on the risk level of the corresponding software modification. For example, the apparatus 200 may determine the software modification is associated with a high risk level and, in response, cause the corresponding test scheduling data object to be rendered in a yellow color.

At operation 524, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that initiate performance of the one or more testing operations indicated by the test scheduling data object. In some embodiments, the apparatus 200 initiates the performance of the testing operation at a testing environment. In some embodiments, the apparatus 200 initiates performance of a testing operation for one or more test case data objects associated with the software modification or software program modified by the software modification.

At operation 527, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that obtain test performance data. In some embodiments, the apparatus 200 generates the test performance data based on an outcome of the testing operation. In some embodiments, the apparatus 200 receives the test performance data from a testing environment that performs the testing operation and generates the test performance data based on performance of the modified software program in one or more test case data objects of the testing operation.

At operation 530, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that determine one or more test failures based on the test performance data. For example, the apparatus 200 may compare one or more outputs generated by the software program to one or more expected outputs. Based on the comparison, the apparatus 200 may determine whether the software program satisfied one or more benchmarks, requisite functions, or other objectives of the testing operation or test case data object. In another example, the apparatus 200 may determine whether the software program performed the testing operation within a predetermined threshold, such as a maximum runtime or whether the software program demonstrated at least a threshold level of stability and/or responsiveness. In some embodiments, the apparatus 200 determines whether the test failure occurred based on a deficit or error in a test case data object, such as an omitted identifier, omitted or incorrect simulated graphical user interface element, or an incorrect simulated input.

At operation 533, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that optionally provide a notification indicative of the test failure to one or more computing devices. In some embodiments, the apparatus 200 generates the notification based on the test failure and/or the test performance data such that the notification may indicate one or more aspects of the software program or software modification (e.g., improper output, threshold-violating runtime, instability, etc.,) that resulted in the test failure. In some embodiments, the apparatus 200 provides the notification to a subset of a plurality of computing devices associated with the software program and/or software modification based on a development flow data object.

At operation 536, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that generate a communication bridge. In some embodiments, the apparatus 200 generates the communication bridge between a plurality of computing devices indicated in a development flow data object. In some embodiments, based on the development flow data object, the apparatus 200 generates the communication bridge between a subset of a plurality of computing devices associated with the development flow data object. Non-limiting examples of the communication bridge include teleconference communication sessions, videoconferencing sessions, telephone calls, instant message conversation chains or channels, and grouped instant messages.

At operation 539, the apparatus 200 includes means such as the data intake circuitry 209, the data processing circuitry 211, the data analysis circuitry 213, the optional testing circuitry 215, the communications circuitry 205, the input/output circuitry 207, the processor 201, and/or the like, or a combination thereof, that perform one or more appropriate actions. In some embodiments, the apparatus 200 provides a notification indicative of the communication bridge to the subset of the plurality of computing devices. In some embodiments, the apparatus 200 modifies the distributed scheduling data object based on the communication bridge. For example, the apparatus 200 generates a second test scheduling data object indicative of the communication bridge and modifies the distributed scheduling data object based on the second test scheduling data object.

In some embodiments, the apparatus 200 generates, using a model, such as a machine learning model, one or more test case corrections based on the test failure and/or test performance data. In some embodiments, the apparatus applies the test case correction to the corresponding test case data object, which may include providing the test case correction and/or modified test case data object to the testing environment. In some embodiments, the apparatus 200 modifies a status of the change request data object based on the test failure. In some embodiments, the apparatus 200 modifies the test scheduling data object associated with the change request data object to indicate the status of the change request data object. In some embodiments, the apparatus 200 generates one or more correction data objects that indicate or include one or more service-level agreement (SLA) impacts. In some embodiments, the apparatus 200 determines and performs one or more root cause corrective actions (RCCAs) on the software modification based on the correction data object.

In some embodiments, the apparatus 200 generates an incident report based on the test failure and/or test performance data. In some embodiments, the apparatus 200 provides the incident report to one or more computing devices based on the development flow data object. The incident report may include an outcome of one or more testing operations. For example, the apparatus 200 may determine, and the incident report may include a quantity of passed testing operations, a quantity of skipped testing operations, and a quantity of failed testing operations. In some embodiments, the apparatus 200 stores data associated with the testing of the software modification in one or more data stores. For example, the apparatus 200 stores the change request data object, test scheduling data object, test performance data, and/or incident report in one or more data stores, potentially in association with one or more user accounts, an identifier for the software program modified, and/or an identifier for the software modification.

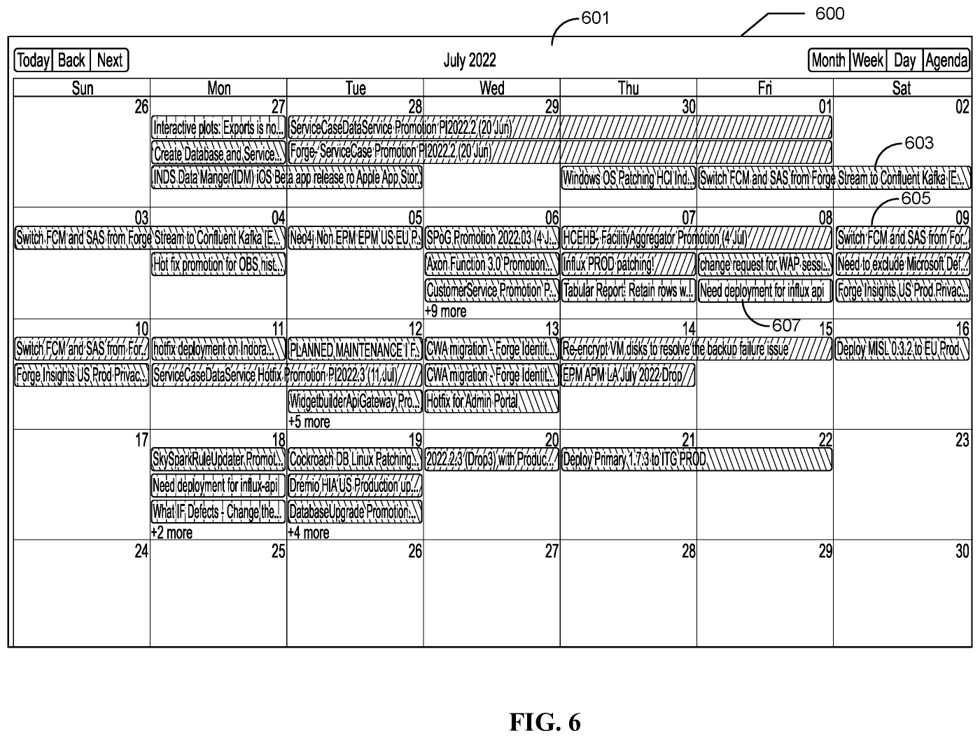

FIG. 6. is an example user interface 600 that depicts a distributed scheduling data object 601, where at least some of the various named aspects of the UI may be generated in accordance with the previously described and depicted figures. In some embodiments, the distributed scheduling data object 601 is a collaborative digital calendar accessible by a plurality of user accounts and/or computing devices. In some embodiments, the distributed scheduling data object 601 includes a plurality of test scheduling data objects that that define a date and/or time for performing an action, such as a testing operation or a communication bridge. For example, the distributed scheduling data object 601 may include a test scheduling data object 603, a test scheduling data object 605, and a test scheduling data object 607. In some embodiments, each of the test scheduling data object 603, test scheduling data object 605, and test scheduling data object 607 are associated with a different change request data object indicative of a software modification. In some embodiments, when rendered on the user interface 600 within the distributed scheduling data object 601, each of the each of the test scheduling data object 603, test scheduling data object 605, and test scheduling data object 607 include a description or summary of a testing operation. In some embodiments, each of the test scheduling data object 603, test scheduling data object 605, and test scheduling data object 607 are rendered on the user interface 600 in a particular color based on a risk level of the software modification with which the test scheduling data object is associated. For example, the test scheduling data object 603 may be associated with a software modification for which the modification management system determines a risk level corresponding to a low risk category. Based on the risk level and/or low risk category, the modification management system may render the test scheduling data object 603 on the user interface 600 in a green color. In another example, the test scheduling data object 605 may be associated with a software modification for which the modification management system determines a risk level corresponding to a medium risk category. Based on the risk level and/or medium risk category, the modification management system may render the test scheduling data object 605 on the user interface 600 in a blue color. In another example, the test scheduling data object 607 may be associated with a software modification for which the modification management system determines a risk level corresponding to a no-risk category. Based on the risk level and/or no-risk category, the modification management system may render the test scheduling data object 607 on the user interface 600 in a grey color.

In some embodiments, the modification system receives user inputs for generating a change request data object by receiving selections to the distributed scheduling data object 601 within the user interface 600. For example, the modification system receives a user input selecting a particular time area on the rendering of the distributed scheduling data object 601. Based on the user input, the modification system may generate a change request data object (e.g., and/or additional user interface for receiving additional inputs for the change request data object) indicative of a testing operation for a software modification, where a date and time of the testing operation are determined based on the particular time area. In another example, the user interface 600 includes a selectable field that, upon selection via a user input, causes the modification management system to generate a change request data object and perform additional operations, such as generating a test scheduling data object and modifying the distributed scheduling data object 601.

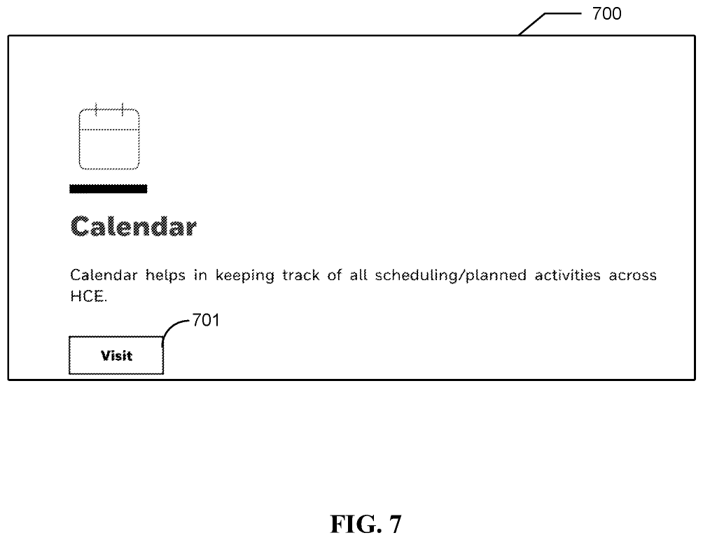

FIG. 7. is an example user interface 700 that depicts a selectable field 701 for accessing a distributed scheduling data object, where at least some of the various named aspects of the UI may be generated in accordance with the previously described and depicted figures. In some embodiments, the modification management system renders the user interface 700 on a webpage or within an application installed on or accessed by a computing device. In some embodiments, in response to receiving a user input selecting the selectable field 701, the modification management system renders a user interface including a distributed scheduling data object, such as the user interface 600.

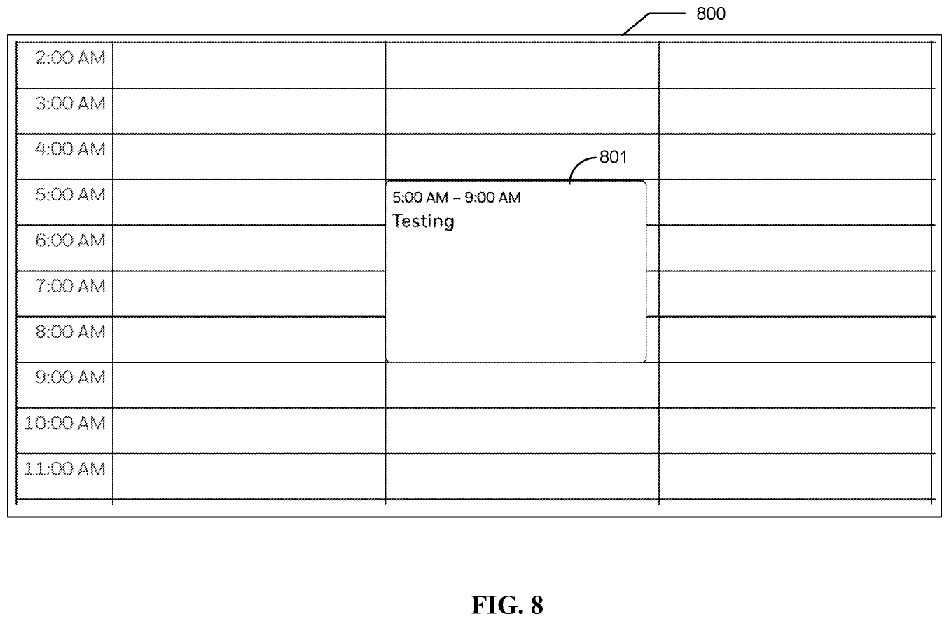

FIG. 8. is an example user interface 800 that depicts a test scheduling data object 801, where at least some of the various named aspects of the UI may be generated in accordance with the previously described and depicted figures. In some embodiments, the test scheduling data object 801 includes a time interval. The time interval may indicate an expected downtime associated with performing a testing operation for a software modification. The expected downtime may refer to a time during which a software program, or services and/or functionality provided thereby, is unavailable, offline or not operational. In some embodiments, the modification system renders the user interface 800 in response to receiving a user input selecting a rendering of a test scheduling data object within a user interface for a distributed test scheduling data object, such as the user interface 600.

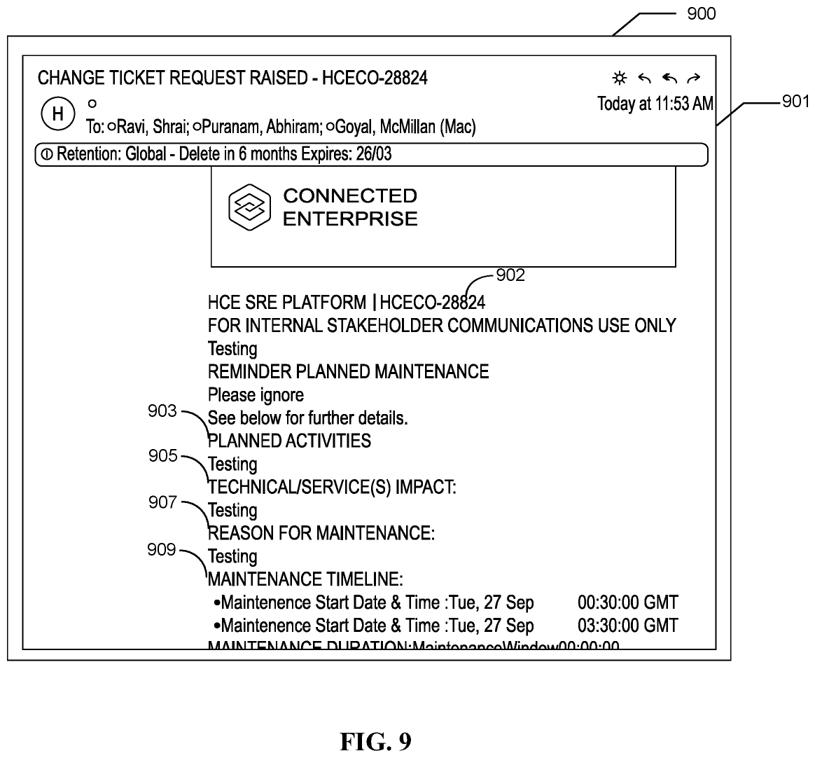

FIG. 9. is an example user interface 900 that depicts a notification 901 indicative of a change request data object, where at least some of the various named aspects of the UI may be generated in accordance with the previously described and depicted figures. In some embodiments, the modification management system generates the notification 901 in response to generating a change request data object and/or test scheduling data object. In some embodiments, the notification 901 includes an identifier 902 that indicates a software modification and/or associated software program to be tested during a testing operation associated with the change request data object. Additionally, or alternatively, in some embodiments, the identifier 902 indicates a product or service with which the software program is associated. In some embodiments, the modification management system determines the identifier 902 based on the change request data object and/or a development flow data object associated with the software program to-be-modified. In some embodiments, the identifier 902 is associated with a test scheduling data object.

In some embodiments, the notification 901 includes a planned activity field 903 that indicates an action to be performed, such as a testing operation. In some embodiments, the planned activity field 903 indicates one or more test case data objects based upon which the testing operation may be performed. In some embodiments, the notification 901 includes an impacted services field 905 that indicates one or more services, products, or other functionality that may be impacted during performance of the testing operation. For example, the impacted services field 905 may indicate that a particular service, product, or other functionality may be inoperative or inaccessible during performance of the testing operation. In some embodiments, the notification 901 includes one or more rationales 907 for the change request data object, such as performance of a testing operation or generation of a communication bridge in response to a test failure. In some embodiments, the notification 901 includes a timeline 909 indicative of a date and/or duration of one or more testing operations.

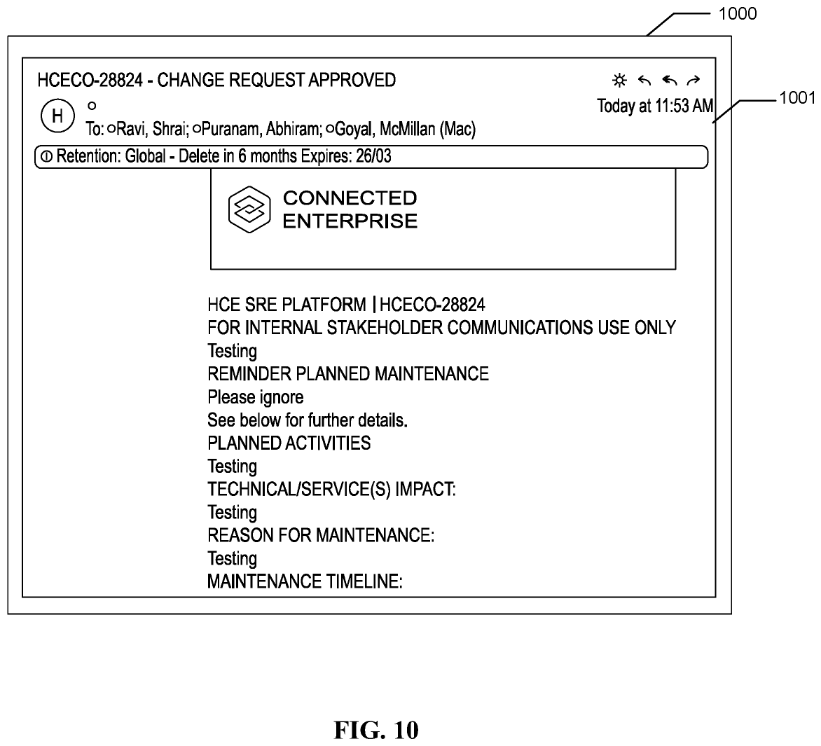

FIG. 10. is an example user interface 1000 that depicts a notification 1001 indicative of a change request data object, where at least some of the various named aspects of the UI may be generated in accordance with the previously described and depicted figures. In some embodiments, the modification management system generates the notification 1001 in response to generating a change request data object and/or test scheduling data object or in response to receiving an administrator approval for a change requests data object from an administrator user account or computing device. For example, the notification 1001 may indicate that the change request data object and/or associated testing operation has been approved.

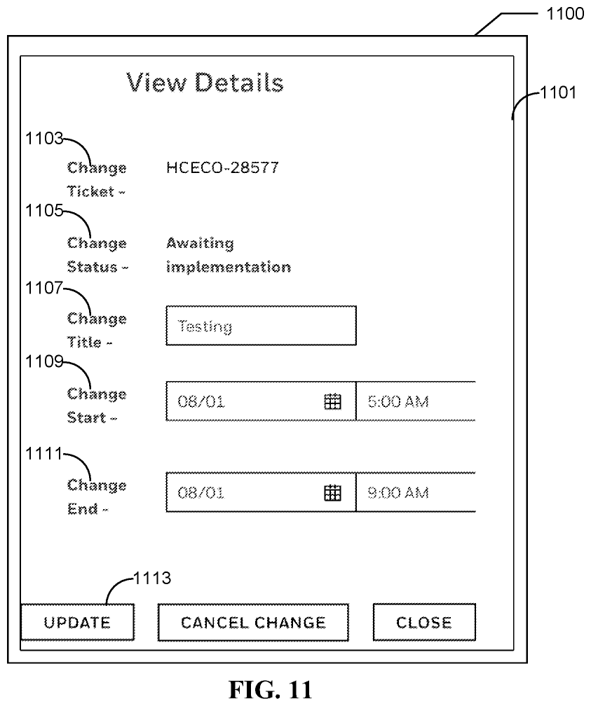

FIG. 11. is an example user interface 1100 that depicts a change request data object 1101, where at least some of the various named aspects of the UI may be generated in accordance with the previously described and depicted figures. In some embodiments, the modification management system generates the user interface 1100 in response to receiving a user input selecting a portion of user interface that depicts a notification for the change request data object. For example, the modification management may generate the user interface 1100 in response to receiving an input for a selectable summary field.

In some embodiments, the change request data object 1101 includes an identifier 1103 associated with the change request data object 1101 and/or a test scheduling data object generated in response to the change request data object 1101. In some embodiments, the change request data object 1101 incudes a status 1105 that corresponds to a status of the change request data object 1101, an associated testing operation, and/or associated software modification. In one example, the status 1105 indicates that a software modification is awaiting implementation, awaiting administrator approval, awaiting testing, has passed a testing operation, or has failed a testing operation. In some embodiments, the change request data object 1101 includes a title 1107 that indicates a rationale for the change request data object 1101 (e.g., testing software modification, communication bridge responsive to a test failure, etc.,), a title of a software modification, and/or a title of a software program associated with the software modification. In some embodiments, the change request data object 1101 includes a start time 1109 and an end time 1111 that correspond to a start time and end time of a testing operation or a communication bridge. In some embodiments, the status 1105, title 1107, start time 1109, and/or end time 1111 are configurable. For example, the user interface 1100 may include a selectable update field 1113. In response to a user input selecting the selectable update field 1113, the modification management system may update the user interface 1100 such that the status 1105, title 1107, start time 1109, and/or end time 1111 may be adjusted via receiving user inputs. In some embodiments, in response to determining a test failure, the modification management system may prevent or disable adjustment of the change request data object 1101 and/or associated test scheduling data object.

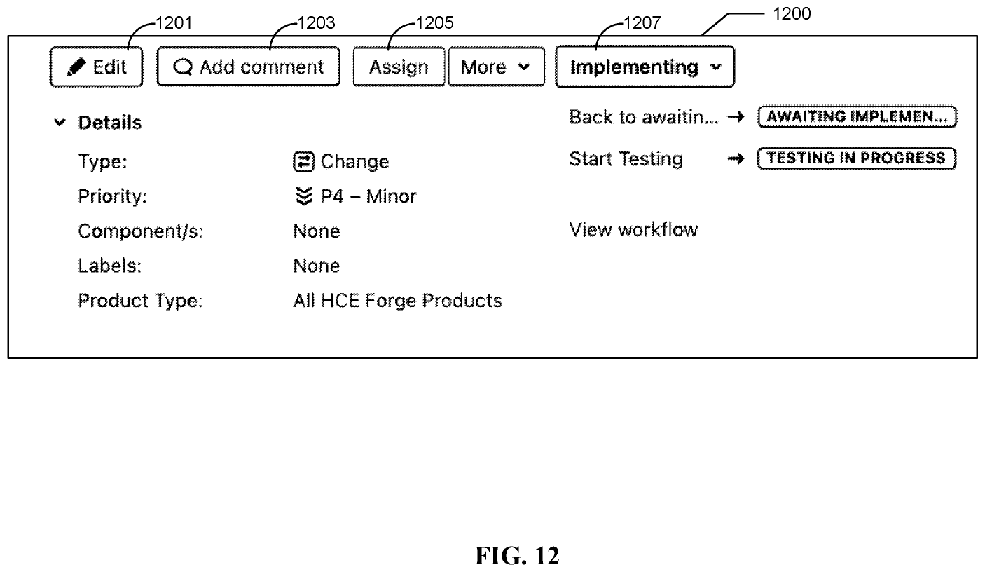

FIG. 12. is an example user interface 1200 for managing a change request data object, where at least some of the various named aspects of the UI may be generated in accordance with the previously described and depicted figures. In some embodiments, the modification management system generates and causes rendering of the user interface 1200 in response to receiving a user input selecting a change request data object from within a notification or selecting a test scheduling data object associated with the change request data object. In some embodiments, the user interface 1200 includes information associated with the change request data object including a type (e.g., software change, software replacement, software upgrade, etc.,), a priority level for performing a testing operation associated with the change request data object or modifying a software program based on a software modification, one or more components of the software program to-be-modified, one or more labels of the software modification, and one or more product types associated with the software program. In some embodiments, the user interface 1200 includes a selectable field 1201 for initiating one or more editing operations for the change request data object. In some embodiments, the user interface 1200 includes a selectable field 1203 for providing one or more comments respective to the change request data object, which may be stored in association with the change request data object and included in one or more notifications indicative of the change request data object. In some embodiments, the user interface 1200 includes a selectable field 1205 for assigning the change request data object to one or more user accounts or computing devices such that notifications associated with the change request data object and/or associated testing operation are provided to the assigned user account or computing device. In some embodiments, the user interface 1200 includes a selectable field 1207 for modifying a status of the change request data object. For example, based on user inputs to the selectable field 1207, the modification management system may modify a status of the change request data object from awaiting implementation to testing in progress (e.g., to indicate initiation of the associated testing operation for the software modification). In some embodiments, the modification management system automatically modifies the status of the change request data object and updates the user interface 1200 based on the updated status.

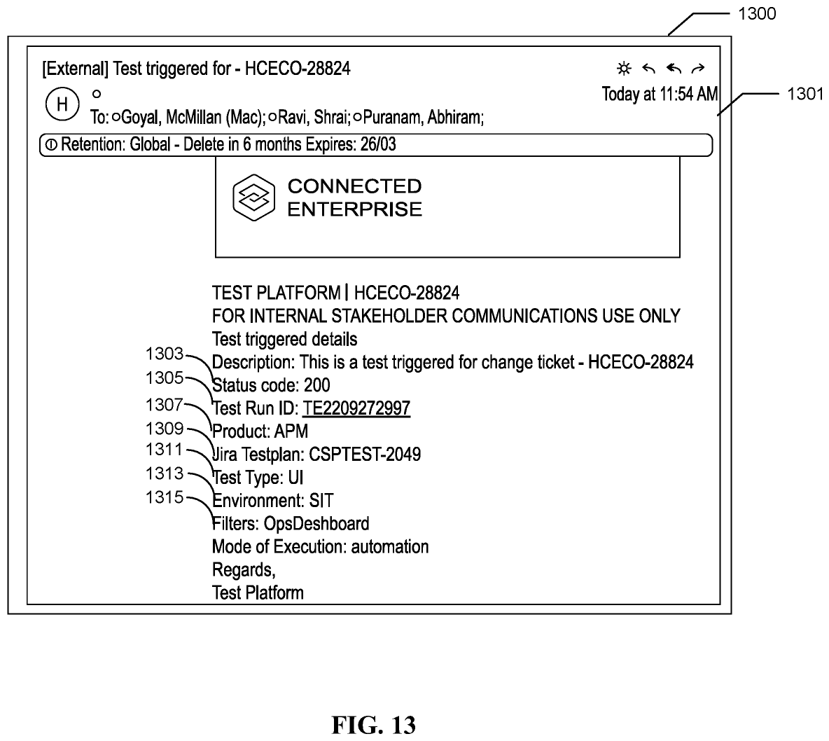

FIG. 13. is an example user interface 1300 that depicts a notification 1301 indicative of a testing operation, where at least some of the various named aspects of the UI may be generated in accordance with the previously described and depicted figures. In some embodiments, the modification management system generates the user interface 1300 in response to initiating performance of a testing operation. In some embodiments, the notification 1301 includes one or more status codes 1303 associated with the testing operation. In one example, the status code 1303 is a hypertext transfer protocol (HTTP) status code indicative of a status of the testing operation, such as a successful status, a redirected or skipped status, a client error status, a server error status, or an informational status. In some embodiments, the modification management system generates the status based on test performance data.

In some embodiments, the notification 1301 includes a test identifier 1305 associated with the testing operation. In some embodiments, the notification 1301 includes a product identifier 1307 that indicates a particular product or product type associated with tested software modification or software program. For example, the product identifier 1307 may indicate that a testing operation, software modification, and/or software program is associated with an asset performance management (APM) product. In some embodiments, the notification 1301 includes a test case data object identifier 1309 that indicates one or more test case data objects that define one or more aspects of the testing operation, such as a testing plan for the testing operation. In some embodiments, the notification 1301 includes a test type 1311 that indicates a type of the testing operation, such as simulated graphical user interface, usability test, compatibility test, integration test (e.g., including top-down or bottom-up incremental testing or non-incremental testing), unit testing, system testing, security testing, and performance testing (e.g., including load testing, stress testing, scalability testing, and/or stability testing). In some embodiments, the notification 1301 includes an environment identifier 1313 that indicates a testing environment associated with the testing operation, such as a systems integration testing environment, performance testing environment, user acceptance testing environment, quality assurance testing environment, security testing environment, or chaos testing environment. In some embodiments, the notification 1301 includes a filter identifier 1315 that indicates one or more network environments or applications at which test performance data for a testing operation may be accessed or observed. In some embodiments, the notification 1301 indicates that the testing operation was automatically initiated by the modification management system.

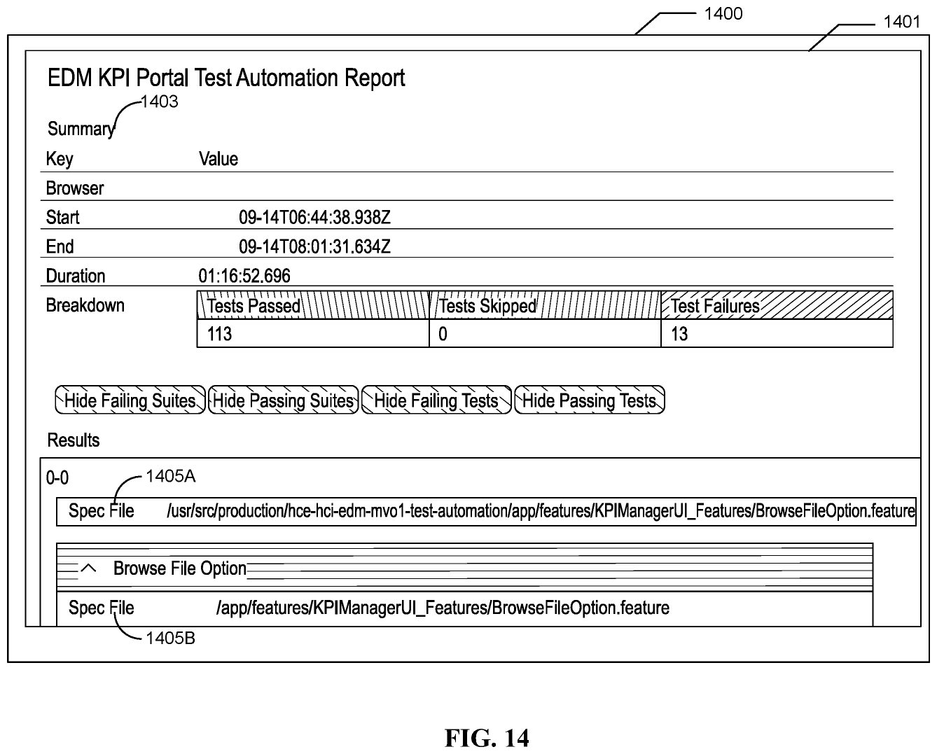

FIG. 14. is an example user interface 1400 that depicts an incident report 1401, where at least some of the various named aspects of the UI may be generated in accordance with the previously described and depicted figures. In some embodiments, the incident report 1401 includes a testing operation summary 1403 including performance data associated with one or more testing operations. In some embodiments, the testing operation summary 1403 indicates a start time, end time, and/or duration of the testing operation. In some embodiments, the testing operation summary 1403 indicates a quantity of passed testing operations, a quantity of skipped testing operations, and a quantity of failed testing operations. In some embodiments, the incident report 1401 includes one or more specification file links 1405A, 1405A that allow a computing device to access or observe test performance data associated with the test operation, one or more test case data objects associated with the testing operation, and/or a software modification associated with the testing operation.

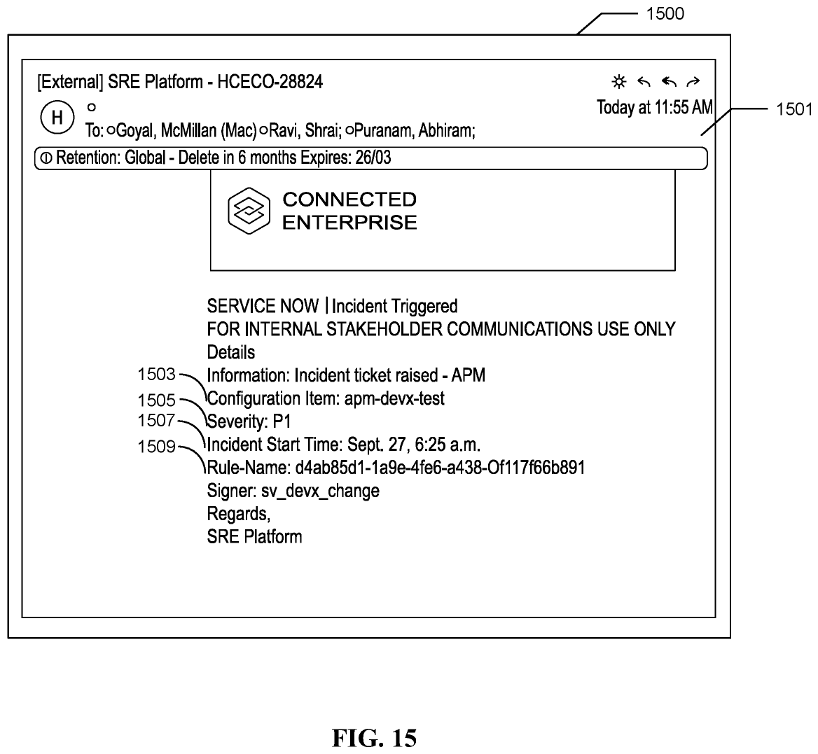

FIG. 15. is an example user interface 1500 that depicts a notification 1501 indicative of a test failure, where at least some of the various named aspects of the UI may be generated in accordance with the previously described and depicted figures. In some embodiments, the notification 1501 includes a testing operation identifier 1503 associated with a testing operation corresponding to the test failure. In some embodiments, the notification 1501 includes a severity level 1505 associated with the test failure. In some embodiments, the severity level 1505 embodies one or more service-level agreement (SLA) impacts. In one example, a first severity level 1505 indicates that a tested software modification resulted in a down status or major malfunction resulting in a product inoperative condition in which users would be unable to perform their normal functions. In another example, a second severity level 1505 indicates that a tested software modification resulted in critical loss of software program functionality or performance that would result in a high number of users unable to perform their normal functions (e.g., a software program may be usable but severely limited in functionality). In another example, a third severity level 1505 indicates that a tested software modification resulted in a moderate loss of software program functionality or performance that would result in multiple users impacted in their normal functions. In still another example, a fourth severity level 1505 indicates that a tested software modification resulted in a minor loss of software program functionality that would result in users experiencing minor difficulties or complexity in performing their normal functions. The modification management system may generate the severity level 1505 based on the test performance data.

In some embodiments, the notification 1501 includes a timestamp 1507 that indicates a time and/or date of the test failure. In some embodiments, the notification 1501 includes one or more identifiers 1509 that indicate a test case object, or rule or other criteria defined thereby, associated with the test failure.

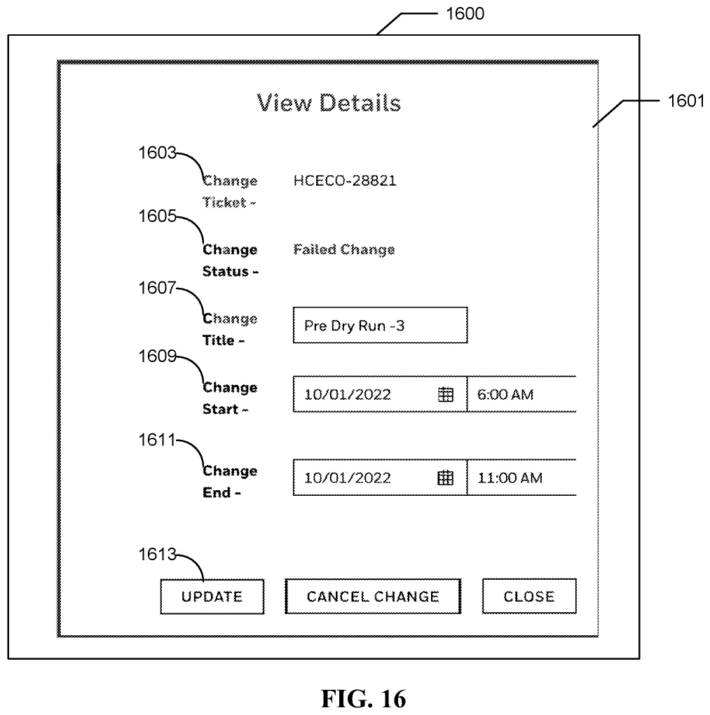

FIG. 16. is an example user interface 1600 that depicts a change request data object 1601, where at least some of the various named aspects of the UI may be generated in accordance with the previously described and depicted figures. In some embodiments, the modification management may generate the user interface 1600 in response to determining a test failure and/or generating a communication bridge.

In some embodiments, the change request data object 1601 includes an identifier 1603 associated with the change request data object 1601. In some embodiments, the change request data object 1601 incudes a status 1605 that corresponds to a status of the change request data object 1601, an associated testing operation, and/or associated software modification. In one example, the status 1605 indicates that a software modification has failed a testing operation. In some embodiments, the change request data object 1601 includes a title 1607 that indicate a title of the testing operation associated with the test failure. In some embodiments, the change request data object 1601 includes a start time 1609 and an end time 1616 that correspond to a start time and end time of a communication bridge or additional testing operation. In some embodiments, the status 1605, title 1607, start time 1609, and/or end time 1616 are configurable. For example, the user interface 1600 may include a selectable update field 1613. In response to a user input selecting the selectable update field 1613, the modification management system may update the user interface 1600 such that the status 1605, title 1607, start time 1609, and/or end time 1616 may be adjusted via receiving user inputs.

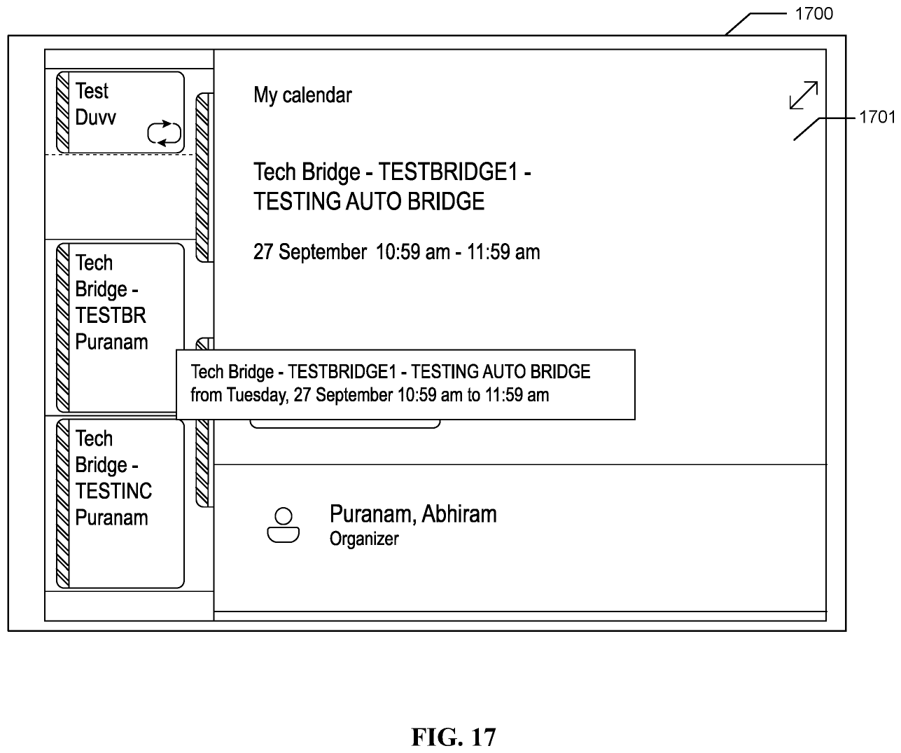

FIG. 17. is an example user interface 1700 that depicts a notification 1701 indicative of a communication bridge, where at least some of the various named aspects of the UI may be generated in accordance with the previously described and depicted figures. In some embodiments, the notification 1701 includes a date and time for the communication bridge. In some embodiments, the notification 1701 indicates one or more user accounts, or users, that may participate in the communication bridge. In some embodiments, the notification 1701 may be an entry in a distributed scheduling data object or a personal scheduling data object, such as a personal digital calendar.

### Conclusion

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations. multitasking and parallel processing may be advantageous.

What is claimed is:

1. A computer-implemented method, comprising:
receiving a change request data object indicative of a software modification;
generating a risk level of the software modification based on the change request data object;
generating a test scheduling data object based on the change request data object and the risk level of the software modification, wherein the test scheduling data object is indicative of at least one testing operation for the software modification;
initiating performance of the at least one testing operation at a testing environment;
receiving, from the testing environment, test performance data;
determining at least one test failure based on the test performance data; and
in response to determining the at least one test failure, generating a communication bridge between at least a subset of a plurality of computing devices based on the at least one test failure and a development flow data object.

2. The computer-implemented method of claim 1, further comprising:
in response to determining the risk level of the software modification exceeds a risk threshold, flagging the change request data object for administrator approval; and
providing an administrator approval request to one of the plurality of computing devices based on the development flow data object.

3. The computer-implemented method of claim 1, further comprising:
modifying a distributed scheduling data object based on the test scheduling data object.

4. The computer-implemented method of claim 3, further comprising:
providing a graphical user interface (GUI) indicative of the distributed scheduling data object to the plurality of computing devices; and
rendering the test scheduling data object on the GUI in one of a plurality of colors based on the risk level of the software modification.

5. The computer-implemented method of claim 1, wherein:
the at least one testing operation comprises one or more test case data objects; and
the computer-implemented method further comprises:
generating, using a machine learning model, at least one test case correction based on the at least one test failure; and
applying the at least one test case correction to the one or more test case data objects.

6. The computer-implemented method of claim 1, further comprising:
modifying a status of the change request data object based on the at least one test failure, wherein the test scheduling data object is indicative of the status of the change request data object.

7. The computer-implemented method of claim 1, further comprising:
providing a notification indicative of the test scheduling data object to the plurality of computing devices based on the development flow data object.

8. The computer-implemented method of claim 1, wherein generating the communication bridge comprises:
generating a teleconference communication session between at least the subset of the plurality of computing devices.

9. The computer-implemented method of claim 1, wherein generating the communication bridge comprises:
generating a second test scheduling data object; and
providing a notification indicative of the second test scheduling data object to at least the subset of the plurality of computing devices.

10. The computer-implemented method of claim 1, further comprising:
modifying a distributed scheduling data object based on the second test scheduling data object.

11. The computer-implemented method of claim 1, further comprising:
querying the development flow data object based on the at least one test failure to determine the subset of the plurality of computing devices, wherein the development flow data object defines associations between a plurality of user accounts and the plurality of computing devices.

12. A computing apparatus comprising at least one processor and at least one non-transitory memory having computer-coded instructions stored thereon, the computer-coded instructions configured to, in execution with the at least one processor, cause the computing apparatus to:
receive a change request data object indicative of a software modification;
generate a risk level of the software modification based on the change request data object;
generate a test scheduling data object based on the change request data object and the risk level of the software modification, wherein the test scheduling data object is indicative of at least one testing operation for the software modification;
initiate performance of the at least one testing operation at a testing environment;
receive, from the testing environment, test performance data;
determine at least one test failure based on the test performance data; and
in response to determining the at least one test failure, generate a communication bridge between at least a subset of a plurality of computing devices based on the at least one test failure and a development flow data object.

13. The computing apparatus of claim 12, wherein the computer-coded instructions, when executed by the at least one processor, further cause the computing apparatus to:
provide a notification indicative of the at least one testing operation to at least a subset of the plurality of computing devices based on the development flow data object.

14. The computing apparatus of claim 13, wherein the computer-coded instructions, when executed by the at least one processor, further cause the computing apparatus to:
provide a notification indicative of the communication bridge and the at least one test failure to at least a subset of the plurality of computing devices based on the at least one test failure and the development flow data object.

15. The computing apparatus of claim 12, wherein the computer-coded instructions, when executed by the at least one processor, further cause the computing apparatus to:
generate, based on the at least one test failure, at least one correction data object indicative of one or more service-level agreement (SLA) impacts.

16. The computing apparatus of claim 15, wherein the computer-coded instructions, when executed by the at least one processor, further cause the computing apparatus to:
perform one or more root cause corrective actions (RCCAs) on the software modification based on the at least one correction data object.

17. The computing apparatus of claim 12, wherein the computer-coded instructions, when executed by the at least one processor, further cause the computing apparatus to:
generate an incident report based on the at least one test failure; and
provide the incident report to the plurality of computing devices.

18. The computing apparatus of claim 12, wherein:
the change request data object indicates a downtime metric associated with the at least one testing operation; and
the risk level is generated based on the downtime metric.

19. The computing apparatus of claim 12, wherein the at least one testing operation comprises a simulated graphical user interface test.

20. A computer program product comprising at least one non-transitory, computer-readable storage medium including instructions that, upon execution by at least one processor, configure the computer program product to:
receive a change request data object indicative of a software modification;
generate a risk level of the software modification based on the change request data object;
generate a test scheduling data object based on the change request data object and the risk level of the software modification, wherein the test scheduling data object is indicative of at least one testing operation for the software modification;
initiate performance of the at least one testing operation at a testing environment;
receive, from the testing environment, test performance data;
determine at least one test failure based on the test performance data; and
in response to determining the at least one test failure, generate a communication bridge between at least a subset of a plurality of computing devices based on the at least one test failure and a development flow data object.
